(19) United States
(12) Patent Application Publication
(10) Pub. No.: US 2026/0259396 A1
(43) Pub. Date: Sep. 3, 2026

(54) ZOOM LENS AND IMAGE PICKUP APPARATUS

(71) Applicant: CANON KABUSHIKI KAISHA, Tokyo (JP)

(72) Inventor: Tomoya YAMADA, Saitama (JP)

(21) Appl. No.: 19/460,557

(22) Filed: Jan. 27, 2026

(30) Foreign Application Priority Data
Feb. 28, 2025 (JP) 2025-031666

(51) Int. Cl. G02B 15/14; G02B 15/16

(52) U.S. Cl. CPC G02B 15/145; G02B 15/1441; G02B 15/1461; G02B 15/16

(57) ABSTRACT

A zoom lens may include, in order from an object side to an image side, a first lens unit with positive refractive power that does not move for zooming, an intermediate group having two or more lens units that move for zooming, and a rear lens unit. The zoom lens may further include an aperture stop that does not move during zooming. Each distance between adjacent lens units may change during zooming. Predetermined inequalities may be satisfied.

### BACKGROUND

### Field of the Technology

The present disclosure relates to a zoom lens and an image pickup apparatus.

### Description of the Related Art

A zoom lens may have high optical performance, a reduced size, and a wide angle of view. Japanese Patent Application Laid-Open No. 2021-032924 discloses a zoom lens that includes, in order from the object side to the image side, a first lens unit with positive refractive power that does not move for zooming, a plurality of lens units that move for zooming, and a rear lens unit that does not move for zooming.

### SUMMARY

A zoom lens according to one aspect of the present disclosure may include, in order from an object side to an image side, a first lens unit with positive refractive power that does not move for zooming, an intermediate group having two or more lens units that move for zooming, and a rear lens unit. The zoom lens may further include an aperture stop that does not move during zooming. Each distance between adjacent lens units may change during zooming. The following inequalities may be satisfied:

$$0.03 \leq fw / T L \leq 0 \text{.0390}$$

$$0.05 \leq fl / TL \leq 0.19$$

$$4. \leq f t / fw \leq 7.000$$

$$- 2.4 \; 00 \leq β r \leq - 1.27$$

where f1 is a focal length of the first lens unit, fw is a focal length of the zoom lens at a wide-angle end, ft is a focal length of the zoom lens at a telephoto end, TL is a distance on an optical axis from a lens surface closest to an object in the zoom lens to a final lens surface closest to an image plane in the zoom lens in an in-focus state on an object at infinity at the wide-angle end, plus an air-equivalent distance on the optical axis from the final lens surface to the image plane, and βr is a combined lateral magnification at the wide-angle end of all lens units that are closer to the image plane than a lens unit with negative refractive power closest to the image plane in the intermediate group. Alternatively, the zoom lens further includes an aperture stop that moves during zooming. The following inequalities are satisfied:

$$0.025 \leq fw / T L \leq 0 \text{.0350}$$

$$0.05 \leq fl / TL \leq 0.1 \; 900$$

$$4. \leq f t / fw \leq 7.000$$

where f1 is a focal length of the first lens unit, fw is a focal length of the zoom lens at a wide-angle end, ft is a focal length of the zoom lens at a telephoto end, and TL is a distance on an optical axis from a lens surface closest to an object in the zoom lens to a final lens surface closest to an image plane in the zoom lens in an in-focus state on an object at infinity at the wide-angle end, plus an air-equivalent distance on the optical axis from the final lens surface to the image plane. An image pickup apparatus having the above zoom lens also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1 at a wide-angle end.

FIGS. 2A and 2B are aberration diagrams of the zoom lens according to Example 1 at the wide-angle and a telephoto ends.

FIG. 3 is a sectional view of a zoom lens according to Example 2 at a wide-angle end.

FIGS. 4A and 4B are aberration diagrams of the zoom lens according to Example 2 at the wide-angle and a telephoto ends.

FIG. 5 is a sectional view of a zoom lens according to Example 3 at a wide-angle end.

FIGS. 6A and 6B are aberration diagrams of the zoom lens according to Example 3 at the wide-angle and a telephoto ends.

FIG. 7 is a sectional view of a zoom lens according to Example 4 at a wide-angle end.

FIGS. 8A and 8B are aberration diagrams of the zoom lens according to Example 4 at the wide-angle and a telephoto ends.

FIG. 9 is a sectional view of a zoom lens according to Example 5 at a wide-angle end.

FIGS. 10A and 10B are aberration diagrams of the zoom lens according to Example 5 at the wide-angle and a telephoto ends.

FIG. 11 is a sectional view of a zoom lens according to Example 6 at a wide-angle end.

FIGS. 12A and 12B are aberration diagrams of the zoom lens according to Example 6 at the wide-angle end and a telephoto end.

FIG. 13 is a sectional view of a zoom lens according to Example 7 at a wide-angle end.

FIGS. 14A and 14B are aberration diagrams of the zoom lens according to Example 7 at the wide-angle end and a telephoto end.

FIG. 15 is a sectional view of a zoom lens according to Example 8 at a wide-angle end.

FIGS. 16A and 16B are aberration diagrams of the zoom lens according to Example 8 at the wide-angle end and a telephoto end.

FIG. 17 is a sectional view of a zoom lens according to Example 9 at a wide-angle end.

FIGS. 18A and 18B are aberration diagrams of the zoom lens according to Example 9 at the wide-angle end and a telephoto end.

FIG. 19 illustrates an image pickup apparatus having any one of the zoom lenses according to Examples 1 to 9.

### DESCRIPTION OF THE EMBODIMENTS

Referring now to the accompanying drawings, a detailed description will be given of examples according to the present disclosure.

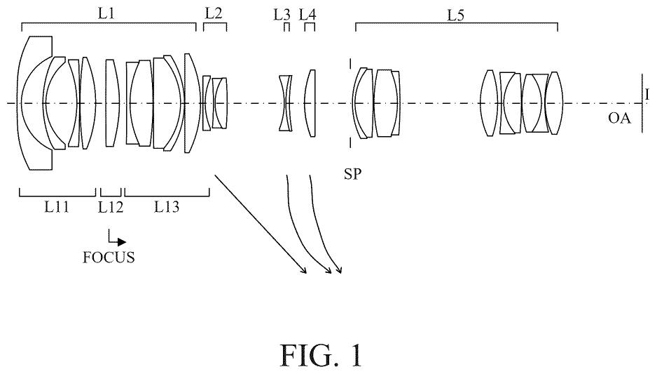

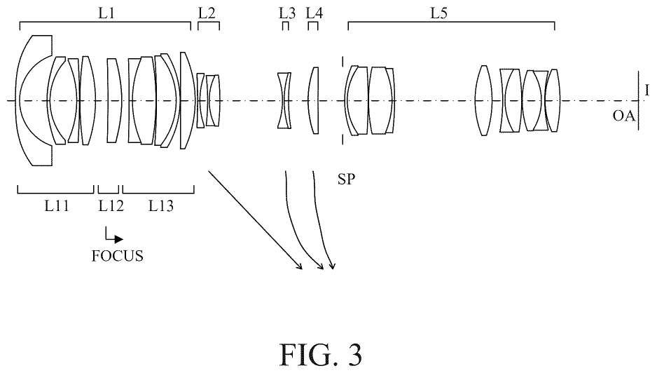

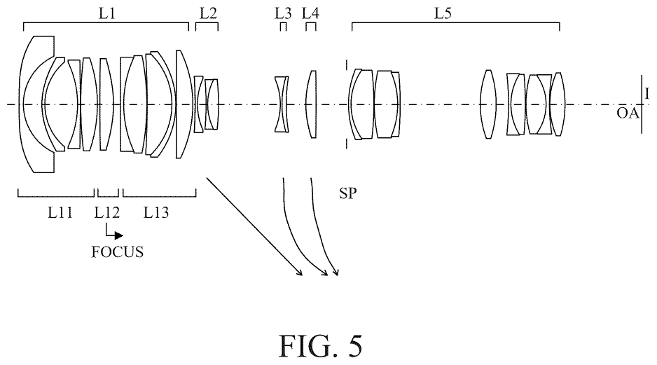

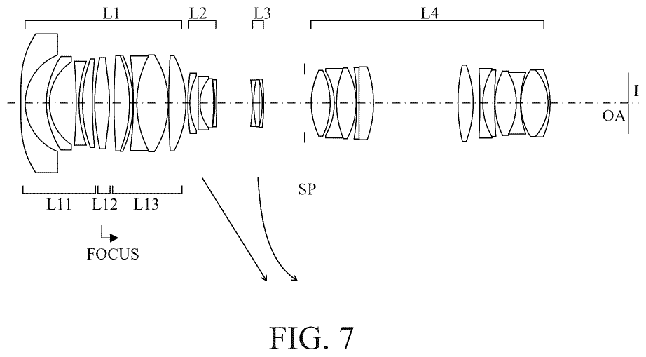

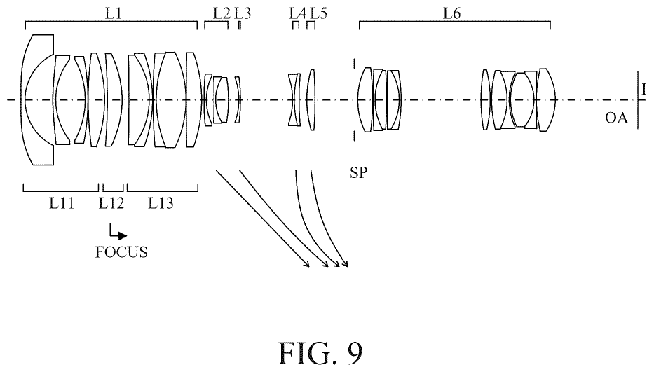

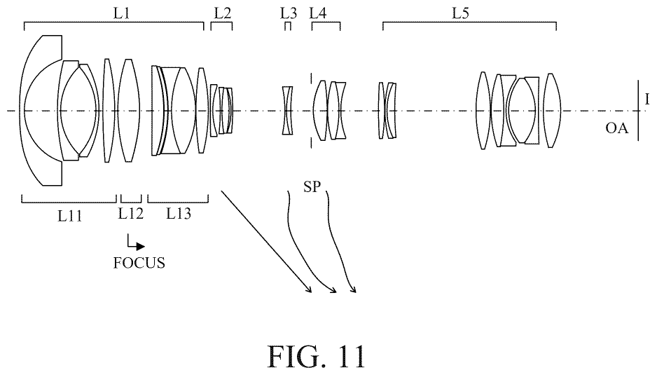

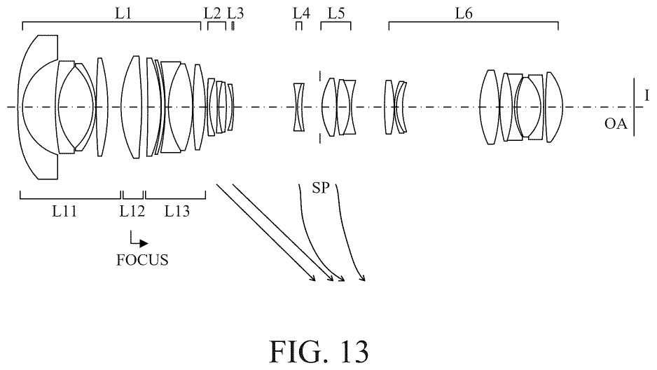

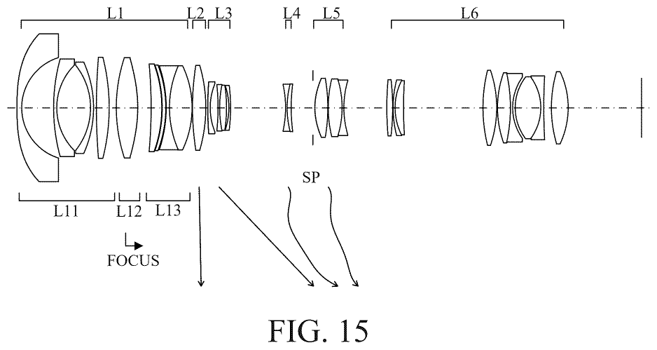

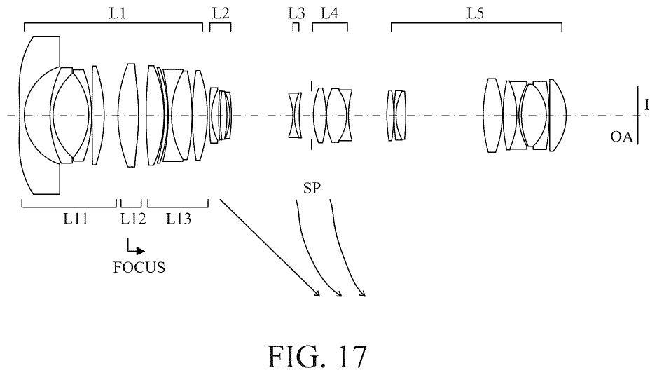

FIGS. 1, 3, 5, 7, 9, 11, 13, 15, and 17 respectively illustrate cross sections of zoom lenses according to Examples 1 to 9 in an in-focus state on an object at infinity (referred to as “in an in-focus state at infinity” hereinafter) at a wide-angle end. The zoom lens according to each example is used for a variety of image pickup apparatus such as cinema cameras, broadcasting cameras, video cameras, surveillance cameras, digital still cameras, and film-based cameras.

In a zoom lens, a lens unit is a group of one or more lenses that may or may not move as a unit during magnification variation (zooming) and focusing between the wide-angle end and a telephoto end, and each distance between adjacent lens units changes during zooming. The lens unit may include an aperture stop. The wide-angle end and telephoto end respectively indicate the zoom states with the maximum angle of view (minimum focal length) and minimum angle of view (maximum focal length) when the lens unit that moves during zooming is located at both ends of a mechanically and controllably movable range along the optical axis.

In each diagram, the left side is the object side (front side) and the right side is the image side (rear side). OA represents an optical axis of the zoom lens. Li represents an i-th lens unit counted from the object side, and L1m is an m-th sub-lens unit counted from the object side in the first lens unit L1. SP represents an aperture stop, and I represents an image plane. An imaging surface (light-receiving surface) of the image sensor in the image pickup apparatus or a film surface (photosensitive surface) of the silver film is located on image plane I. An optical block without refractive power, such as an optical filter, may be located between the lens with refractive power closest to the image plane I in the zoom lens and image plane I.

In each figure, an arrow below a lens unit that moves during zooming indicates a moving locus of that lens unit during zooming from the wide-angle end to the telephoto end. An arrow labeled FOCUS below the lens unit (sub-lens unit) that moves during focusing indicates a moving direction of that lens unit during focusing from infinity to a close distance.

The zoom lens according to each example includes a plurality of lens units, which include, in this order from the object side to the image side, a first lens unit L1 with positive refractive power that does not move for zooming, an intermediate group including two or more intermediate lens units LM (M=2 to 5) that move for zooming, and a rear lens unit LR (R=4 to 6). The zoom lens further includes an aperture stop SP that either does not move or moves during zooming.

In each example, the first lens unit L1 includes a first sub-lens unit L11 that does not move for focusing, a second sub-lens unit L12 that moves for focusing, and a third sub-lens unit L13 that does not move for focusing. The second sub-lens unit L12 moves toward the image side during focusing from infinity to a close distance.

The zoom lenses according to Examples 1, 2, and 3 include two or more intermediate lens units LM, which include, in order from the object side to the image side, a second lens unit L2 as a variator unit with negative refractive power, a third lens unit L3 with negative refractive power, and a fourth lens unit L4 with positive refractive power. The second lens unit L2 moves monotonically toward the image side during zooming from the wide-angle end to the telephoto end. The third lens unit L3 and fourth lens unit L4 move toward the image side along different trajectories during zooming from the wide-angle end to the telephoto end.

The rear lens unit LR includes a fifth lens unit L5 with positive refractive power. An optical unit such as an extender lens for focal length conversion may be inserted within the fifth lens unit L5. The aperture stop SP is located between the fourth lens unit L4 and the fifth lens unit L5 and does not move during zooming.

By placing the aperture stop SP within the rear lens unit LR or adjacent to the rear lens unit LR and not moving during zooming, space can be created for each intermediate lens unit LM to move, making it possible to achieve a zoom lens with a high magnification variation ratio. This is similarly applicable to Examples 4 and 5, which will be described later.

The zoom lens according to Example 4 includes two or more intermediate lens units LM, which include, in order from the object side to the image side, a second lens unit L2 with negative refractive power that serves as a variator unit, and a third lens unit L3 with negative refractive power. The second lens unit L2 moves monotonically toward the image side during zooming from the wide-angle end to the telephoto end. The third lens unit L3 moves toward the image side during zooming from the wide-angle end to the telephoto end.

The rear lens unit LR includes a fourth lens unit L4 with positive refractive power. An optical unit such as an extender lens may be inserted into the fourth lens unit L4. The aperture stop SP is disposed between the third lens unit L3 and the fourth lens unit L4 and does not move during zooming.

The zoom lens according to Example 5 has two or more intermediate lens units LM, which include, in order from the object side to the image side, a second lens unit L2 with negative refractive power as a variator unit, a third lens unit L3 with negative refractive power as a variator unit, a fourth lens unit L4 with negative refractive power, and a fifth lens unit L5 with positive refractive power. The second lens unit L2 and the third lens unit L3 move monotonically toward the image side along slightly different trajectories during zooming from the wide-angle end to the telephoto end. The fourth lens unit L4 and the fifth lens unit L5 move toward the image side on different trajectories during zooming from the wide-angle end to the telephoto end.

The rear lens unit LR includes the sixth lens unit L6 with positive refractive power. An optical unit such as an extender lens may be inserted within the sixth lens unit L6. The aperture stop SP is disposed between the fifth lens unit L5 and the sixth lens unit L6 and does not move during zooming.

In the zoom lenses according to Examples 1 to 5 in which the aperture stop SP does not move during zooming, let f1 be a focal length of the first lens unit L1, let fw be a focal length of the zoom lens at the wide-angle end, and let ft be a focal length of the zoom lens at the telephoto end. The overall optical length TL is defined as a distance on the optical axis from a lens surface closest to the object to the final lens surface closest to the image plane in the in-focus state at infinity at the wide-angle end, plus the air-equivalent distance on the optical axis from the final lens surface to the image plane I. Let βr be a combined lateral magnification at the wide-angle end of all lens units (L4 and L5 in Examples 1 to 3, L4 in Example 4, and L5 and L6 in Example 5) that are closer to the image plane than an intermediate lens with negative refractive power unit closest to the image plane in the intermediate group. Then, at least one of the following inequalities (1) to (4) may be satisfied:

$$0.03 \leq fw / T L \leq 0 \text{.0390} \qquad ( 1 )$$

$$0.05 \leq fl / TL \leq 0.19 \qquad ( 2 )$$

$$4. \leq f t / fw \leq 7.000 \qquad ( 3 )$$

$$- 2.4 \leq β r \leq - 1.27 \qquad ( 4 )$$

The zoom lens according to Example 6 has two or more intermediate lens units LM, which include, in this order from the object side to the image side, a second lens unit L2 with negative refractive power as a variator unit, a third lens unit L3 with negative refractive power, and a fourth lens unit L4 with positive refractive power. The second lens unit L2 moves toward the image side during zooming from the wide-angle end to the telephoto end. The third lens unit L3 and the fourth lens unit L4 move toward the image side along different trajectories during zooming from the wide-angle end to the telephoto end.

The rear lens unit LR includes a fifth lens unit L5 with positive refractive power. The aperture stop SP is disposed closest to the object in the fourth lens unit L4 and moves with the fourth lens unit L4 during zooming. By placing the aperture stop SP within or adjacent to the intermediate lens unit LM and moving it during zooming, the aperture stop SP can be brought closer to the first lens unit L1, thereby reducing the diameter of the first lens unit L1. As a result, a wide-angle zoom lens can be achieved. This is similarly applicable to Examples 7 to 9, which will be described later.

The zoom lens according to Example 7 includes two or more intermediate lens units LM, which include, in order from the object side to the image side, a second lens unit L2 with negative refractive power as a variator unit, a third lens unit L3 with negative refractive power as a variator unit, a fourth lens unit L4 with negative refractive power, and a fifth lens unit L5 with positive refractive power. The second lens unit L2 and the third lens unit L3 move monotonically toward the image side along slightly different trajectories during zooming from the wide-angle end to the telephoto end. The fourth lens unit L4 and the fifth lens unit L5 move toward the image side along different trajectories when zooming from the wide-angle end to the telephoto end.

The rear lens unit LR includes the sixth lens unit L6 with positive refractive power. The aperture stop SP is disposed closest to the object in the fifth lens unit L5 and moves together with the fifth lens unit L5 during zooming.

The zoom lens according to Example 8 includes two or more intermediate lens units LM, which include, in order from the object side to the image side, the second lens unit L2 with positive refractive power, the third lens unit L3 with negative refractive power as a variator unit, the fourth lens unit L4 with negative refractive power, and the fifth lens unit L5 with positive refractive power. The second lens unit L2 moves toward the image side by a small moving amount during zooming from the wide-angle end to the telephoto end. Since the second lens unit L2 moves only a small amount during zooming from the wide-angle end to the telephoto end, it may be considered part of the first lens unit L1. The third lens unit L3 moves monotonically toward the image side during zooming from the wide-angle end to the telephoto end. The fourth lens unit L4 and fifth lens unit L5 move toward the image side along different trajectories during zooming from the wide-angle end to the telephoto end.

The rear lens unit LR includes the sixth lens unit L6 with positive refractive power. The aperture stop SP is disposed closest to the object in the fifth lens unit L5, and moves together with the fifth lens unit L5 during zooming.

The zoom lens according to Example 9 includes two or more intermediate lens units LM, which include, in order from the object side to the image side, a second lens unit L2 with negative refractive power as a variator unit, a third lens unit L3 with negative refractive power, and a fourth lens unit L4 with positive refractive power. The second lens unit L2 moves monotonically toward the image side during zooming from the wide-angle end to the telephoto end. The third lens unit L3 and the fourth lens unit L4 move toward the image side on different trajectories during zooming from the wide-angle end to the telephoto end.

The rear lens unit LR includes a fifth lens unit L5 with positive refractive power. An aperture stop SP is disposed closest to the object in the fourth lens unit L4 and moves together with the fourth lens unit L4 during zooming.

As described above, in the zoom lenses according to Examples 6 to 9, in which the aperture stop SP moves during zooming, let f1 be a focal length of the first lens unit L1, let fw be a focal length of the zoom lens system at the wide-angle end, and let ft be a focal length of the zoom lens system at the telephoto end. Let TL be a distance (overall optical length) on the optical axis from the lens surface closest to the object in the zoom lens to the final lens surface closest to the image plane I in the zoom lens, plus the air-equivalent distance on the optical axis from the final lens surface to image plane I in the in-focus state at infinity at the wide-angle end. In this case, at least one of the following inequalities (1′), (2′), and (3′) may be satisfied:

$$0.025 \leq fw / T L \leq 0 \text{.0350} \qquad ( {1}^{′} )$$

$$0.05 \leq fl / TL \leq 0.1 \; 900 \qquad ( {2}^{′} )$$

$$4. \leq f t / fw \leq 7.000 \qquad ( {3}^{′} )$$

Inequalities (1) and (1′) define a proper relationship between the focal length at the wide-angle end and the overall optical length of the zoom lens to achieve a zoom lens that has a wide angle of view, and a reduced size and weight. In a case where fw/TL becomes higher than the upper limit of inequality (1) or (1′), the overall optical length will be reduced, which is advantageous for making the zoom lens compact and lightweight, but the focal length at the wide-angle end will be too long, making it difficult to achieve a wide angle of view. In a case where fw/TL becomes lower than the lower limit of inequality (1) or (1′), it is advantageous for achieving a wide angle of view, but the overall optical length will be too long, making it difficult to achieve a reduced size and weight.

The lower limit of inequality (1) may be set to 0.0305 or 0.0310. The upper limit of inequality (1) may be set to 0.0385 or 0.0380.

The lower limit of inequality (1′) may be set to 0.0255 or 0.0260. The upper limit of inequality (1′) may be set to 0.0348 or 0.0345.

Inequalities (2) and (2′) define a proper relationship between the focal length of the first lens unit L1 and the overall optical length to obtain a zoom lens that has a wide angle of view, a high magnification variation ratio, high optical performance, and a reduced size and weight. In a case where f1/TL becomes higher than the upper limit of inequalities (2) and (2′), the overall optical length reduces, which is advantageous for making the zoom lens compact and lightweight, but the focal length of the first lens unit L1 becomes too long. In this case, a moving amount of each intermediate lens unit LM to achieve a high magnification variation ratio becomes too large, which tends to increase the distance from the first lens unit L1 to the aperture stop SP. As a result, the diameter of the first lens unit L1 and the size of the zoom lens increase. In a case where f1/TL becomes lower than the lower limit of inequalities (2) and (2′), the focal length of the first lens unit L1 becomes too short, making it difficult to keep the aberrations generated by the first lens unit L1 at the telephoto end within a permissible range. The overall optical length becomes too long, making it difficult to achieve a compact and lightweight zoom lens.

The lower limits of inequalities (2) and (2′) may be set to 0.060 or 0.0700. The upper limits of inequalities (2) and (2′) may be set to 0.1700, 0.150, 0.120, or 0.090.

Inequalities (3) and (3′) define a proper relationship between the focal lengths of a zoom lens at the telephoto end and the wide-angle end to achieve a zoom lens with a high magnification variation ratio and high optical performance. In a case where ft/fw becomes higher than the upper limit of inequality (3) or (3′), the focal length at the telephoto end becomes too long, making it difficult to obtain a zoom lens with a reduced size and weight, and high optical performance. In a case where ft/fw becomes lower than the lower limit of inequality (3) or (3′), it becomes difficult to obtain a zoom lens with a high magnification variation ratio.

The lower limit of inequality (3) or (3′) may be set to 4.050 or 4.100. The upper limit of inequality (3) or (3′) may be set to 6.800, 6.500, 6.000, or 5.500.

Inequality (4) defines a proper range of combined lateral magnification at the wide-angle end of all lens units (subsequent lens units) that are closer to the image plane than the lens unit with negative refractive power closest to the image plane in the intermediate group, and is a condition for obtaining a zoom lens that has a wide angle of view, a high magnification variation ratio, a reduced size and weight, and high optical performance. In a case where βr becomes higher than the upper limit of inequality (4), the combined lateral magnification of the subsequent lens units will be too large, increasing their diameters and making it difficult to achieve a compact and lightweight zoom lens. It increases the various aberrations that occur in the lens units closer to the object than the subsequent lens units, making it difficult to effectively correct them. In a case where βr becomes lower than the lower limit of inequality (4), the combined lateral magnification of the subsequent lens units will be too small, increasing the diameters of the lens units closer to the object than the subsequent lens units, making it difficult to achieve a compact, lightweight zoom lens.

The lower limit of inequality (4) may be set to −2.300 or −2.200. The upper limit of inequality (4) may be set to −1.300, −1.350, or −1.400.

In the zoom lens according to each example, the first sub-lens unit L11 of the first lens unit L1 may have negative refractive power, and the second sub-lens unit L12 and the third sub-lens unit L13 may have positive refractive power. This configuration allows for fluctuations in aberrations associated with focusing to be kept within a permissible range. The configuration of the first lens unit L1 is not limited to the three sub-lens units described above; it may also have a configuration in which a plurality of sub-lens units move for focusing, or it may include four or more sub-lens units.

The first sub-lens unit L11 may include two or more negative lenses. In a case where the first sub-lens unit L11 has only one negative lens, the refractive power of the negative lens in the first sub-lens unit L11 will be too strong to correct chromatic aberration in the first lens unit L1, and it makes it difficult to correct various aberrations other than chromatic aberration, such as spherical aberration.

The two or more negative lenses in the first sub-lens unit L11 may be arranged consecutively in order from the lens closest to the object in the first sub-lens unit L11. This configuration is advantageous for reducing the size and weight of the first sub-lens unit L11.

In the zoom lens according to each example, the intermediate group may have three or more intermediate lens units as the two or more intermediate lens units LM. Moving three or more intermediate lens units to perform zooming can effectively correct various aberrations that occur during zooming.

In the zoom lens according to each example, the intermediate lens unit closest to the object among the two or more intermediate lens units LM may have positive refractive power. In this case, a moving amount of the intermediate lens unit closest to the object during zooming from the wide-angle end to the telephoto end may be 10% or less of the overall optical length TL of the zoom lens. In this case, the focal length f1 of the first lens unit L1 may satisfy each inequality using f1, assuming that it is the combined focal length of the combined lens unit formed by the first lens unit L1 and the intermediate lens unit closest to the object in the in-focus state at infinity at the wide-angle end.

The zoom lens according to each example may satisfy at least one of the following inequalities (5) to (16):

$$- 2.40 \leq fl / fv \leq - 0 \text{.30} \qquad ( 5 )$$

$$- 1.5 \leq fl 1 / fl \leq - 0.60 \qquad ( 6 )$$

$$2. \leq fl 2 / fl \leq 6.5 \qquad ( 7 )$$

$$1. 30 \leq fl 3 / fl \leq 4.50 \qquad ( 8 )$$

$$1.1 \leq LD 1 / fl \leq 6.5 \qquad ( 9 )$$

$$51. 50 ° \leq ω w \leq 65. ° \qquad ( 10 )$$

$$2. \leq Fnow \leq 3.5 \qquad ( 11 )$$

$$0.05 \leq fw / BFw \leq 0.43 \qquad ( 12 )$$

$$0.2 \leq LDs / TL \leq 0.6 \qquad ( 13 )$$

$$2.5 \leq ( fl + bok 1 ) / fl \leq 5. \qquad ( 14 )$$

$$0.6 \leq f t / fl \leq 5. \qquad ( 15 )$$

$$1. 700 \leq fl / fw \leq 5.6 \qquad ( 16 )$$

In inequalities (5) to (16), fv is a focal length of the intermediate lens unit (variator unit) among two or more intermediate lens units LM that has the largest absolute value of the lateral magnification at the telephoto end divided by the lateral magnification in the in-focus state at infinity at the wide-angle end. f11 is a focal length of the first sub-lens unit L11, f12 is a focal length of the second sub-lens unit L12, and f13 is a focal length of the third sub-lens unit L13. LD1 is a length on the optical axis from the lens surface closest to the object in the first lens unit L1 to the lens surface closest to the image plane in the first lens unit Li. Y is an image height of the zoom lens, and ow is a half angle of view ow at the wide-angle end, as ωw=arctan(Y/fw). Fnow is a full aperture F-number of the zoom lens at the wide-angle end. BFw is a distance on the optical axis (back focus) from the lens surface closest to the image plane I in the zoom lens (image-side lens surface of a lens with refractive power closest to the image plane in the zoom lens to the image plane I) to the image plane I. LDs is a distance on the optical axis from the lens surface closest to the object in the first lens unit L1 to the aperture stop SP in the in-focus state at infinity and at the wide-angle end. bok1 is a distance on the optical axis from the lens surface closest to the image plane in the first lens unit L1 to the rear principal point of the first lens unit L1 in the in-focus state at infinity.

Inequality (5) defines a proper relationship between the focal lengths of the first lens unit L1 and the variator unit, and is a condition for obtaining a zoom lens that has a wide angle of view, a high magnification variation ratio, a reduced size and weight, and high optical performance. In a case where f1/fv becomes higher than the upper limit of inequality (5), the focal length of the first lens unit L1 increases, and a moving amount of the variator unit becomes excessively large. As a result, it becomes difficult to obtain a zoom lens with a wide angle of view or a reduced size and weight. Alternatively, the focal length of the variator unit becomes too short, which increases aberration fluctuations during zooming or makes it difficult to reduce the size and weight in order to suppress aberration fluctuations. In a case where f1/fv becomes lower than the lower limit of inequality (5), the focal length of the first lens unit L1 reduces, which makes it difficult to correct various aberrations. Alternatively, the focal length of the variator unit becomes too long relative to the focal length of the first lens unit L1, which makes it difficult to achieve high magnification. In a case where there is an intermediate lens unit adjacent to the variator unit that moves in the same direction as the variator unit during zooming from the wide-angle end to the telephoto end and whose ratio of the moving amount to the variator unit is 10% or less, that intermediate lens unit may also be considered to be part of the variator unit. In this case, the combined focal length at the wide-angle end of the variator unit that includes a plurality of intermediate lens units may be designated as fv.

The lower limit of inequality (5) may be set to −2.30, −2.00, −1.50, or −1.00. The upper limit of inequality (5) may be set to −0.40 or −0.50.

Inequalities (6) to (8) define a proper relationship between the focal lengths of the first lens unit L1, the first sub-lens unit L11, the second sub-lens unit L12, and the third sub-lens unit L13, and represent the conditions for obtaining a zoom lens with high optical performance. In a case where f11/f1 does not satisfy inequality (6), the focal length f1 of the first lens unit L1 or the focal length f11 of the first sub-lens unit L11 will be too small, making it difficult to keep the aberrations generated in the first lens unit L1 or the first sub-lens unit L11 within the permissible range. In a case where fl2/f1 does not satisfy inequality (7), the focal length f1 of the first lens unit L1 or the focal length f11 of the second sub-lens unit L12 will be too small, making it difficult to keep the aberrations generated in the first lens unit L1 or the first sub-lens unit L11 within the permissible range. In a case where fl1/f1 does not satisfy inequality (8), the focal length f1 of the first lens unit L1 or the focal length f13 of the third sub-lens unit L13 will be too small, making it difficult to keep the aberrations generated in the first lens unit L1 or the third sub-lens unit L13 within the permissible range.

The lower limit of inequality (6) may be set to −1.40, −1.30, or −1.20. The upper limit of inequality (6) may be set to −0.65, −0.68, or −0.70.

The lower limit of inequality (7) may be set to 2.10 or 2.20. The upper limit of inequality (7) may be set to 6.00, 5.50, or 5.00.

The lower limit of inequality (8) may be set to 1.50, 1.80, or 2.00. The upper limit of inequality (8) may be set to 4.20, 4.00, or 3.80.

Inequality (9) defines a proper relationship between the thickness and focal length of the first lens unit L1, and is a condition for obtaining a zoom lens that has a reduced size and weight and high optical performance. In a case where LD1/f1 becomes higher than the upper limit of inequality (9), the thickness of the first lens unit L1 will be too large, making it difficult to obtain a compact and lightweight zoom lens. Alternatively, the focal length of the first lens unit L1 will be too short, making it difficult to keep aberration fluctuations associated with focusing within a permissible range. In a case where LD1/f1 becomes lower than the lower limit of inequality (9), the thickness of the first lens unit L1 will be too small, making it difficult to provide the first lens unit L1 with the number of lenses necessary to suppress aberration fluctuations associated with focusing. Alternatively, the focal length of the first lens unit L1 will be too long, increasing the amount of movement of the intermediate lens unit LM during zooming and making it difficult to achieve a compact, lightweight zoom lens.

The lower limit of inequality (9) may be set to 1.30, 1.50, 2.00, 2.50, or 3.00. The upper limit of inequality (9) may be set to 6.00, 5.50, 5.00, or 4.50.

Inequality (10) defines a proper range of the half angle of view when the zoom lens is used for an image pickup apparatus with a diagonal image size of 2Y, and is a condition for achieving a wide-angle, compact, and lightweight zoom lens. Satisfying inequality (10) can increase the angle of view of an image pickup apparatus using image sensors of various sizes. In a case where ow becomes higher than the upper limit of inequality (10), it becomes difficult to obtain a compact and lightweight zoom lens.

The lower limit of inequality (10) may be set to 52.000 or 52.50°. The upper limit of inequality (10) may be set to 63.00° or 60.00°.

Inequality (11) defines a proper range of the full aperture F-number of the zoom lens at the wide-angle end, and is a condition for obtaining a bright zoom lens. In a case where Fnow becomes lower than the lower limit of inequality (11), it becomes difficult to keep spherical aberration, astigmatism, and other aberrations at the wide-angle end within the permissible range. Alternatively, in order to achieve high optical performance, each lens unit must be made larger, which makes it difficult to obtain a compact and lightweight zoom lens. In a case where Fnow becomes higher than the upper limit of inequality (11), the zoom lens will become too dark.

The lower limit of inequality (11) may be set to 2.30, 2.50, or 2.60. The upper limit of inequality (11) may be set to 3.30, 3.10, or 3.00.

Inequality (12) defines a proper relationship between the focal length of the zoom lens system at the wide-angle end and the back focus, and is a condition for obtaining a wide-angle, compact, and lightweight zoom lens. In a case where fw/BFw becomes higher than the upper limit of inequality (12), the focal length at the wide-angle end will be too long relative to the back focus, making it difficult to obtain a wide-angle zoom lens. In a case where fw/BFw becomes lower than the lower limit of inequality (12), the back focus will be too long relative to the focal length at the wide-angle end, making it difficult to obtain a compact and lightweight zoom lens.

The lower limit of inequality (12) may be set to 0.070, 0.100, 0.150, or 0.200. The upper limit of inequality (12) may be set to 0.400, 0.370, 0.330, or 0.300.

Inequality (13) defines a proper relationship between the distance from the object-side lens surface of the first lens unit L1 to the aperture stop SP and the overall optical length in the in-focus state at infinity at the wide-angle end, and is a condition for achieving a wide-angle, compact, and lightweight zoom lens. In a case where LDs/TL becomes higher than the upper limit of inequality (13), the aperture stop SP will be disposed at a position far from a lens surface closest to the object in the first lens unit L1. As a result, the diameter of the first lens unit L1 will be too large to achieve a wide-angle zoom lens, making it difficult to achieve a wide-angle, compact, and lightweight zoom lens. In a case where LDs/TL becomes lower than the lower limit of inequality (13), the aperture stop SP will be disposed at a position far from a lens surface closest to the image plane in the zoom lens. As a result, the diameter of the lens unit closest to the image plane becomes too large, making it difficult to achieve a compact and lightweight zoom lens.

The lower limit of inequality (13) may be set to 0.30, 0.40, or 0.45. The upper limit of inequality (13) may be set to 0.58 or 0.55.

Inequality (14) defines a proper range for the retro ratio (f1+bok1) of the first lens unit L1, and is a condition for achieving a wide-angle, compact, and lightweight zoom lens. Increasing the retro ratio of the first lens unit L1 is advantageous for achieving a wide angle of view, but it increases the diameter of the third sub-lens unit L13 and the number of lenses in the first lens unit L1. In a case where (f1+bok1) becomes higher than the upper limit of inequality (14), the diameter of the third sub-lens unit 13 will increase too much or the number of lenses in the first lens unit L1 will become too large, and it becomes difficult to achieve a compact and lightweight zoom lens. In a case where (f1+bok1) becomes lower than the lower limit of inequality (14), it will be difficult to achieve a wide-angle zoom lens, the diameter of the lens closest to the object in the first lens unit L1 will increase, and it becomes difficult to achieve a compact and lightweight zoom lens.

The lower limit of inequality (14) may be set to 2.600, 2.800, 3.000, or 3.200. The upper limit of inequality (14) may be set to 4.800, 4.500, 4.300, or 4.100.

Inequality (15) defines a proper relationship between the focal length of the first lens unit L1 and the focal length of the zoom lens system at the telephoto end in order to obtain a zoom lens with a high magnification variation ratio, a reduced size and weight, and high optical performance. Increasing ft/f1 is advantageous for obtaining a zoom lens with a high magnification variation ratio, but aberrations generated by the first lens unit L1 are magnified at the telephoto end, making it difficult to keep the aberrations within the permissible range. In a case where ft/f1 becomes higher than the upper limit of inequality (15), the focal length of the first lens unit L1 becomes too short, making it difficult to keep the aberrations generated by the first lens unit L1 within the permissible range at the telephoto end.

Alternatively, the number of lenses in the first lens unit L1 becomes too large, and it is difficult to achieve a compact and lightweight zoom lens. In a case where ft/f1 becomes lower than the lower limit of inequality (15), the focal length of the first lens unit L1 becomes too long, making it difficult to obtain a zoom lens with a high magnification variation ratio. Alternatively, the moving amount of each intermediate lens unit LM during zooming becomes too large, and it becomes difficult to achieve a small and lightweight zoom lens.

The lower limit of inequality (15) may be set to 0.800, 1.000, 1.200, or 1.400. The upper limit of inequality (15) may be set to 4.000, 3.500, 3.000, or 2.500.

Inequality (16) defines a proper relationship between the focal length of the first lens unit L1 and the focal length of the zoom lens system at the wide-angle end in order to obtain a zoom lens with a wide angle of view, a reduced size and weight, and high optical performance. In a case where f1/fw becomes higher than the upper limit of inequality (16), the diameter of the first lens unit L1 increases, making it difficult to obtain a compact zoom lens. In a case where f1/fw becomes lower than the lower limit of inequality (16), it becomes difficult to obtain a wide-angle zoom lens or to keep coma aberration, curvature of field, etc. at the wide-angle end within the permissible range.

The lower limit of inequality (16) may be set to 1.750 or 1.800. The upper limit of inequality (16) may be set to 5.000, 4.000, 3.600, or 3.000.

In the zoom lens according to each example, the rear lens unit does not move during zooming, but all or part of the sub-lens units of the rear lens unit may move during zooming. For example, in Example 1, the fifth lens unit L5, which serves as the rear lens unit, may move during zooming. Since a substantially afocal light beam enters the lens surface closest to the object in the fifth lens unit L5 from the object side, even if the fifth lens unit L5 moves, the optical characteristics other than the back focus remain substantially unchanged. Therefore, the fifth lens unit L5 can be moved to compensate for focus changes caused by manufacturing errors, temperature changes, or attitude changes in the zoom lens.

Next, numerical examples 1 to 9 corresponding to Examples 1 to 9, respectively, will be illustrated. In each numerical example, i represents the order of an optical surface counted from the object side. r represents a radius of curvature (mm) of an i-th optical surface, and d represents a distance (lens thickness or air thickness (mm)) between i-th and (i+1)-th optical surfaces. (Variable) in d indicates that the air thickness changes during zooming. The correspondence between air thickness and focal length is illustrated in a separate table. nd represents a refractive index for the d-line of an optical material between i-th and (i+1)-th optical surfaces. vd represents an Abbe number of the optical material based on the d-line. The Abbe number vd based on the d-line is defined as follows:

$$v d = ( n d - 1 ) / ( n F - n C )$$

where nF, nd, and nC are refractive indices for the F-line (wavelength 486.1 nm), d-line (wavelength 587.6 nm), and C-line (wavelength 656.3 nm) in the Fraunhofer lines.

The various data listed include the focal length (mm) of the zoom lens for the d-line (wavelength 587.6 nm), the half angle of view ω(°), and the maximum image height corresponding to the half angle of view as “image height.” The half-angle of view ω is expressed as follows:

$$ω = arc tan ( Y / fw )$$

where 2Y is a diagonal image size of the image pickup apparatus in which the zoom lens is used, and fw is a focal length of the zoom lens at the wide-angle end.

The maximum image height corresponds to Y, which is half of the diagonal image size 2Y (for example, when 2Y=29.60 mm, Y=14.80 mm). BF is the back focus (mm), which is a distance on the optical axis from the final lens surface closest to the image plane to the paraxial image plane, expressed as an air-equivalent length. The overall lens length is a distance on the optical axis from the front lens surface closest to the object to the final lens surface of the zoom lens, plus the back focus, and corresponds to the overall optical length TL.

An asterisk “*” next to a surface number indicates that the optical surface is aspherical. The aspherical shape is expressed by the following equation:

$$X = \frac{{H}^{2} / R}{1 + \sqrt{1 - ( 1 + k ) {( H / R )}^{2}}} + A 4 \cdot + {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 3 \cdot {H}^{3} + A 5 \cdot {H}^{5} + A 7 \cdot {H}^{7} + A 9 \cdot {H}^{9} + A 11 \cdot {H}^{11} + A 13 \cdot {H}^{13} + A 15 \cdot {H}^{15}$$

where X is a displacement amount from a surface vertex in the optical axis direction, H is a height from the optical axis in a direction orthogonal to the optical axis, a light traveling direction is positive, R is a paraxial radius of curvature, K is a conic constant, and A3 to A16 are aspheric coefficients. The conic constant and aspheric coefficient e±M mean x10^{±M}.

The lens unit data indicates the starting surface and focal length in each lens unit. WIDE represents a wide-angle end, MIDDLE represents an intermediate zoom position, and TELE represents a telephoto end.

Table 1 summarizes the values of inequalities (1) through (16) for each numerical example. The zoom lenses according to numerical examples 1 to 5 satisfy all of inequalities (1) to (4) and (5) to (16), and the zoom lenses according to numerical examples 6 to 9 satisfy all of inequalities (1′) to (3′) and inequalities (5) to (16).

### Numerical Example 1

UNIT: mm
SURFACE DATA

| Surface No. | r | d | nd | vd |
|---|---|---|---|---|
| 1* | 26370.983 | 2.15 | 1.90525 | 35.0 |
| 2 | 25.769 | 11.04 | | |
| 3* | 50.047 | 1.50 | 1.88300 | 40.8 |
| 4 | 26.803 | 15.85 | | |
| 5 | −52.153 | 1.40 | 2.00100 | 29.1 |
| 6 | −514.230 | 0.20 | | |
| 7 | 166.616 | 8.01 | 1.92286 | 18.9 |
| 8 | −59.949 | 5.18 | | |
| 9 | 1579.614 | 7.00 | 1.59522 | 67.7 |
| 10* | −65.339 | 3.71 | | |
| 11 | −1254.167 | 1.70 | 2.00069 | 25.5 |
| 12 | 48.319 | 11.73 | 1.49700 | 81.5 |
| 13 | −155.449 | 0.21 | | |
| 14 | 1789.973 | 13.88 | 1.43875 | 94.7 |
| 15 | −34.780 | 2.00 | 1.91650 | 31.6 |
| 16 | −44.567 | 0.20 | | |
| 17 | −36400.381 | 8.05 | 1.69930 | 51.1 |
| 18 | −56.180 | (Variable) | | |
| 19* | −1117.897 | 1.20 | 1.69930 | 51.1 |
| 20 | 32.125 | 4.20 | | |
| 21 | −148.088 | 0.82 | 1.88300 | 40.8 |
| 22 | 23.509 | 6.20 | 1.78880 | 28.4 |
| 23 | −151.683 | (Variable) | | |
| 24 | −35.559 | 0.85 | 1.53775 | 74.7 |
| 25 | 53.686 | 1.80 | 1.85478 | 24.8 |
| 26 | 79.225 | (Variable) | | |
| 27* | 43.850 | 5.36 | 1.71736 | 29.5 |
| 28 | −10837.450 | (Variable) | | |
| 29 (SP) | ∞ | 1.00 | | |
| 30 | 40.103 | 1.30 | 2.05090 | 26.9 |
| 31 | 27.538 | 9.23 | 1.53172 | 48.8 |
| 32 | −260.043 | 0.45 | | |
| 33 | 74.392 | 12.00 | 1.48749 | 70.2 |
| 34 | −42.184 | 1.30 | 2.00100 | 29.1 |
| 35 | −203.464 | 41.07 | | |
| 36 | 38.740 | 8.89 | 1.43875 | 94.7 |
| 37 | −52.924 | 1.91 | | |
| 38 | −148.399 | 1.20 | 2.00100 | 29.1 |
| 39 | 22.919 | 9.01 | 1.89286 | 20.4 |
| 40 | −164.418 | 0.30 | | |
| 41 | 48.813 | 9.92 | 1.43875 | 94.7 |
| 42 | −23.944 | 1.71 | 2.00100 | 29.1 |
| 43 | 57.516 | 0.20 | | |
| 44 | 36.664 | 9.06 | 1.48749 | 70.2 |
| 45 | −41.397 | 40.59 | | |

| | |
|---|---|
| Image Plane | ∞ |

ASPHERIC DATA
1st Surface

| | | | |
|---|---|---|---|
| K = 0.00000e+00 | A 4 = 1.13075e−05 | A 6 = −1.19162e-08 | A 8= 9.01150e−12 |
| A10 = −1.96581e−15 | A12 = −3.56941e−18 | A14= 3.66370e-21 | A16 = −1.21144e−24 |

3rd Surface

| | | | |
|---|---|---|---|
| K = 0.00000e+00 | A 4 = −2.63185e−06 | A 6 = −7.27956e−10 | A8 = −3.61729e−12 |
| A10 = 1.06773e−13 | A12 = −2.90229e-16 | A14 = 2.67601e−19 | |

10th Surface

| | | | |
|---|---|---|---|
| K = 0.00000e+00 | A 4 = 2.85123e−06 | A 6 = −1.01285e-09 | A 8 = −9.44276e−13 |
| A 3 = 1.00487e−06 | A 5 = 4.16484e−09 | A 7 = 3.72608e−11 | |

19th Surface

| | | | |
|---|---|---|---|
| K = 0.00000e+00 | A 4 = 4.06457e-06 A | 6 = −2.38082e−08 | A 8 = 2.05429e−10 |
| A10 = −1.06222e−12 | A12 = 2.35470e−15 | | |

27th Surface

| | | | |
|---|---|---|---|
| K = 0.00000e+00 | A 4 = −2.88291e-06 | A 6 = 3.72138e−09 | A 8 = −4.97460e−12 |

VARIOUS DATA

| ZOOM RATIO | 4.20 | | |
|---|---|---|---|
| | WIDE | MIDDLE | TELE |
| Focal Length | 10.00 | 20.50 | 42.01 |
| Fno | 2.72 | 2.73 | 3.65 |
| Half Angle of View (°) | 55.95 | 35.83 | 19.41 |
| Image Height | 14.80 | 14.80 | 14.80 |
| Overall Lens Length | 319.55 | 319.55 | 319.55 |
| BF | 40.59 | 40.59 | 40.59 |
| d18 | 1.17 | 28.67 | 47.64 |
| d23 | 29.16 | 6.95 | 5.25 |
| d26 | 7.70 | 7.66 | 0.98 |
| d28 | 18.18 | 12.91 | 2.34 |

LENS UNIT DATA

| Lens Unit | Starting Surface | Focal Length |
|---|---|---|
| 1 | 1 | 23.07 |
| 2 | 19 | −37.03 |
| 3 | 24 | −49.64 |
| 4 | 27 | 60.89 |
| 5 | 29 | 70.71 |

### Numerical Example 2

UNIT: mm
SURFACE DATA

| Surface No. | r | d | nd | vd |
|---|---|---|---|---|
| 1* | 183.509 | 2.15 | 1.90525 | 35.0 |
| 2 | 24.087 | 14.00 | | |
| 3* | 50.180 | 1.50 | 1.88300 | 40.8 |
| 4 | 29.765 | 13.67 | | |
| 5 | −49.244 | 1.40 | 2.00100 | 29.1 |
| 6 | −319.022 | 0.20 | | |
| 7 | 158.322 | 7.97 | 1.92286 | 18.9 |
| 8 | −67.874 | 6.37 | | |
| 9 | −695.713 | 7.00 | 1.59522 | 67.7 |
| 10* | −66.565 | 3.77 | | |
| 11 | −736.697 | 1.70 | 2.00069 | 25.5 |
| 12 | 52.528 | 12.06 | 1.59410 | 60.5 |
| 13 | −120.674 | 0.21 | | |
| 14 | −300.326 | 10.09 | 1.43875 | 94.7 |
| 15 | −36.334 | 2.00 | 1.91650 | 31.6 |
| 16 | −45.922 | 0.20 | | |
| 17 | ∞ | 7.48 | 1.69930 | 51.1 |
| 18 | −58.880 | (Variable) | | |
| 19* | −265.632 | 1.20 | 1.69930 | 51.1 |
| 20 | 38.843 | 3.95 | | |
| 21 | −108.472 | 0.82 | 1.88300 | 40.8 |
| 22 | 28.909 | 5.46 | 1.78880 | 28.4 |
| 23 | −114.173 | (Variable) | | |
| 24 | −37.078 | 0.85 | 1.53775 | 74.7 |
| 25 | 46.695 | 2.26 | 1.85478 | 24.8 |
| 26 | 82.227 | (Variable) | | |
| 27* | 48.922 | 5.04 | 1.71736 | 29.5 |
| 28 | 928.043 | (Variable) | | |
| 29 (SP) | ∞ | 1.00 | | |
| 30 | 44.860 | 1.30 | 2.05090 | 26.9 |
| 31 | 28.952 | 10.66 | 1.53172 | 48.8 |
| 32 | −246.831 | 0.20 | | |
| 33 | 78.153 | 12.00 | 1.48749 | 70.2 |
| 34 | −40.778 | 1.30 | 2.00100 | 29.1 |
| 35 | −133.975 | 41.07 | | |
| 36 | 46.735 | 8.71 | 1.43875 | 94.7 |
| 37 | −54.504 | 5.40 | | |
| 38 | −92.054 | 1.20 | 2.00100 | 29.1 |
| 39 | 30.885 | 8.50 | 1.89286 | 20.4 |
| 40 | −89.801 | 0.30 | | |
| 41 | 45.633 | 9.73 | 1.43875 | 94.7 |
| 42 | −28.044 | 1.71 | 2.00100 | 29.1 |
| 43 | 62.810 | 0.20 | | |
| 44 | 37.709 | 7.65 | 1.48749 | 70.2 |
| 45 | −71.937 | 39.99 | | |
| Image Plane | ∞ | | | |

ASPHERIC DATA
1st Surface
K = 0.00000e+00 A 4 = 8.79520e−06 A 6 = −7.38303e−09 A 8 = 4.23172e−12
A10 = 2.34534e−15 A12 = −6.46927e−18 A14 = 4.97396e−21 A16 = −1.47719e−24
3rd Surface
K = 0.00000e+00 A 4 = −4.06853e−06 A 6 = 5.81069e−10 A 8 = −2.47073e−12
A10 = 6.81538e−14 A12 = −2.02500e−16 A14 = 2.08706e−19
10th Surface
K = 0.00000e+00 A 4 = 2.08931e−06 A 6 = −2.70180e−10 A 8 = −8.29142e−13
A 3 = 9.79858e−07 A 5 = 7.80187e−10 A 7 = 1.72211e−11
19th Surface
K = 0.00000e+00 A 4 = 2.71692e−06 A 6 = −2.04573e−08 A 8 = 2.07708e−10
A10 = −1.09233e−12 A12 = 2.23810e−15
27th Surface
K = 0.00000e+00 A 4 = −1.45811e−06 A 6 = 1.82030e−09 A 8 = −1.79204e−12
VARIOUS DATA

| ZOOM RATIO | 4.09 | | |
|---|---|---|---|
| | WIDE | MIDDLE | TELE |
| Focal Length | 11.00 | 22.25 | 45.00 |
| Fno | 2.72 | 2.73 | 3.65 |
| Half Angle of View (°) | 53.38 | 33.63 | 18.21 |
| Image Height | 14.80 | 14.80 | 14.80 |
| Overall Lens Length | 318.02 | 318.02 | 318.02 |
| BF | 39.99 | 39.99 | 39.99 |
| d18 | 1.20 | 29.30 | 48.67 |
| d23 | 31.93 | 8.15 | 3.53 |
| d26 | 9.97 | 9.39 | 1.00 |
| d28 | 12.64 | 8.91 | 2.54 |

LENS UNIT DATA

| Lens Unit | Starting Surface | Focal Length |
|---|---|---|
| 1 | 1 | 25.88 |
| 2 | 19 | −40.34 |
| 3 | 24 | −54.84 |
| 4 | 27 | 71.82 |
| 5 | 29 | 68.82 |

### Numerical Example 3

UNIT: mm
SURFACE DATA

| Surface No. | r | d | nd | vd |
|---|---|---|---|---|
| 1* | 9276.246 | 2.15 | 1.90525 | 35.0 |
| 2 | 27.003 | 9.51 | | |
| 3* | 35.717 | 1.50 | 1.88300 | 40.8 |
| 4 | 28.085 | 16.81 | | |
| 5 | −49.867 | 1.40 | 2.00100 | 29.1 |
| 6 | −1005.683 | 0.20 | | |
| 7 | 198.552 | 8.56 | 1.92286 | 18.9 |
| 8 | −72.501 | 1.30 | | |
| 9 | 1229.524 | 7.00 | 1.59522 | 67.7 |
| 10* | −60.440 | 3.54 | | |
| 11 | 3426.893 | 1.70 | 2.00069 | 25.5 |
| 12 | 57.143 | 11.86 | 1.49700 | 81.5 |
| 13 | −124.693 | 0.21 | | |
| 14 | −434.337 | 12.70 | 1.43875 | 94.7 |
| 15 | −35.692 | 2.00 | 1.91650 | 31.6 |
| 16 | −43.199 | 0.20 | | |
| 17 | −90234.679 | 8.50 | 1.69930 | 51.1 |
| 18 | −62.296 | (Variable) | | |
| 19* | −173.993 | 1.20 | 1.69930 | 51.1 |
| 20 | 31.710 | 4.41 | | |
| 21 | −151.890 | 0.82 | 1.88300 | 40.8 |
| 22 | 27.816 | 5.56 | 1.78880 | 28.4 |
| 23 | −113.698 | (Variable) | | |
| 24 | −32.540 | 0.85 | 1.53775 | 74.7 |
| 25 | 49.092 | 2.21 | 1.85478 | 24.8 |
| 26 | 86.868 | (Variable) | | |
| 27* | 49.486 | 5.21 | 1.71736 | 29.5 |
| 28 | −1142.521 | (Variable) | | |
| 29 (SP) | ∞ | 1.00 | | |
| 30 | 46.387 | 1.30 | 2.05090 | 26.9 |
| 31 | 30.575 | 11.75 | 1.53172 | 48.8 |
| 32 | −148.630 | 0.20 | | |
| 33 | 80.374 | 12.00 | 1.48749 | 70.2 |
| 34 | −41.688 | 1.30 | 2.00100 | 29.1 |
| 35 | −174.156 | 41.07 | | |
| 36 | 49.100 | 8.16 | 1.43875 | 94.7 |
| 37 | −55.601 | 6.36 | | |
| 38 | −137.778 | 1.20 | 2.00100 | 29.1 |
| 39 | 29.198 | 7.43 | 1.89286 | 20.4 |
| 40 | −163.757 | 0.30 | | |
| 41 | 54.592 | 10.35 | 1.43875 | 94.7 |
| 42 | −24.908 | 1.71 | 2.00100 | 29.1 |
| 43 | 94.313 | 0.20 | | |
| 44 | 40.231 | 7.80 | 1.48749 | 70.2 |
| 45 | −55.638 | 39.34 | | |
| Image Plane | ∞ | | | |

ASPHERIC DATA
1st Surface
K = 0.00000e+00 A 4 = 1.13386e−05 A 6 = −1.34090e−08 A 8 = 1.37928e−11
A10 = −9.23646e−15 A12 = 3.29596e−18 A14 = 1.16533e−23 A16 = −2.94801e−25
3rd Surface
K = 0.00000e+00 A 4 = −6.02843e−06 A 6 = 4.81093e−09 A 8 = −2.61308e−11
A10 = 1.16845e−13 A12 = −2.42398e−16 A14 = 1.73499e−19
10th Surface
K = 0.00000e+00 A 4 = 3.36349e−06 A 6 = 3.76853e−09 A 8 = 2.37394e−13
A 3 = −4.84936e−07 A 5 = −5.90923e−08 A 7 = −1.00200e−10
19th Surface
K = 0.00000e+00 A 4 = 4.90330e−06 A 6 = −2.82873e−08 A 8 = 2.65298e−10
A10 = −1.29371e−12 A12 = 2.43058e−15
27th Surface
K = 0.00000e+00 A 4 = −1.91764e−06 A 6 = 1.86218e−09 A 8 = −1.89581e−12
VARIOUS DATA

| ZOOM RATIO | 5.00 | | |
|---|---|---|---|
| | WIDE | MIDDLE | TELE |
| Focal Length | 11.00 | 24.60 | 55.00 |
| Fno | 2.72 | 2.72 | 3.66 |
| Half Angle of View (°) | 53.38 | 31.04 | 15.06 |
| Image Height | 14.80 | 14.80 | 14.80 |
| Overall Lens Length | 319.51 | 319.51 | 319.51 |
| BF | 39.34 | 39.34 | 39.34 |
| d18 | 1.20 | 30.87 | 49.93 |
| d23 | 31.69 | 7.11 | 5.53 |
| d26 | 10.08 | 9.89 | 0.99 |
| d28 | 15.70 | 10.80 | 2.21 |

LENS UNIT DATA

| Lens Unit | Starting Surface | Focal Length |
|---|---|---|
| 1 | 1 | 27.22 |
| 2 | 19 | −35.94 |
| 3 | 24 | −49.86 |
| 4 | 27 | 66.24 |
| 5 | 29 | 70.32 |

### Numerical Example 4

UNIT: mm
SURFACE DATA

| Surface No. | r | d | nd | vd |
|---|---|---|---|---|
| 1* | 34960.559 | 2.10 | 1.83481 | 42.7 |
| 2 | 25.044 | 10.28 | | |
| 3* | 35.103 | 1.50 | 1.80400 | 46.5 |
| 4 | 23.989 | 13.00 | | |
| 5 | −235.445 | 1.40 | 1.91650 | 31.6 |
| 6 | 59.555 | 1.71 | | |
| 7 | 60.907 | 4.76 | 1.80810 | 22.8 |
| 8 | 208.438 | 1.20 | | |
| 9 | 98.891 | 7.17 | 1.59522 | 67.7 |
| 10* | −73.731 | 2.17 | | |
| 11 | 294.913 | 7.53 | 1.49700 | 81.5 |
| 12 | −60.508 | 1.70 | 1.95375 | 32.3 |
| 13 | −56.341 | 0.18 | | |
| 14 | −173.321 | 1.70 | 2.00100 | 29.1 |
| 15 | 48.657 | 15.31 | 1.53775 | 74.7 |
| 16 | −43.544 | 0.18 | | |
| 17 | 365.187 | 8.35 | 1.65412 | 39.7 |
| 18 | −48.584 | (Variable) | | |
| 19 | 99.966 | 0.93 | 1.85150 | 40.8 |
| 20 | 28.319 | 4.13 | | |
| 21 | −2609.158 | 0.85 | 1.76385 | 48.5 |
| 22 | 18.928 | 6.65 | 1.85478 | 24.8 |
| 23 | −87.356 | 0.65 | | |
| 24 | −49.469 | 0.75 | 2.00100 | 29.1 |
| 25 | −341.451 | (Variable) | | |
| 26 | −79.639 | 0.70 | 1.83481 | 42.7 |
| 27 | 53.321 | 2.65 | 1.78880 | 28.4 |
| 28 | 1746.164 | 1.53 | | |
| 29 | −40.607 | 0.70 | 1.90525 | 35.0 |
| 30 | −91.150 | (Variable) | | |
| 31 (SP) | ∞ | 3.14 | | |
| 32* | 31.993 | 9.23 | 1.51633 | 64.1 |
| 33 | −36.783 | 2.00 | | |
| 34 | −30.802 | 1.10 | 1.89190 | 37.1 |
| 35 | 44.974 | 9.48 | 1.68893 | 31.1 |
| 36 | −35.581 | 0.32 | | |
| 37 | −117.334 | 1.15 | 1.96300 | 24.1 |
| 38 | 5229.124 | 7.05 | 1.60311 | 60.6 |
| 39 | −51.585 | 41.05 | | |
| 40 | 80.519 | 7.39 | 1.53775 | 74.7 |
| 41 | −52.164 | 3.24 | | |
| 42 | −353.472 | 1.44 | 2.00100 | 29.1 |
| 43 | 31.400 | 5.74 | 1.94594 | 18.0 |
| 44 | 206.797 | 0.20 | | |
| 45 | 33.980 | 10.38 | 1.49700 | 81.5 |
| 46 | −30.342 | 2.00 | 2.05090 | 26.9 |
| 47 | 43.525 | 0.20 | | |
| 48 | 29.986 | 13.22 | 1.53172 | 48.8 |
| 49 | −24.020 | 1.00 | 2.00100 | 29.1 |
| 50 | −40.523 | 37.99 | | |
| Image Plane | ∞ | | | |

ASPHERIC DATA
1st Surface
K = 0.00000e+00 A 4 = 2.21477e−06 A 6 = −4.47868e−07 A 8 = −1.42130e−09
A10 = −2.19658e−13 A12 = 1.90576e−16 A14 = −1.48299e−19 A16 = −1.50672e−23
A 3 = −4.81538e−06 A 5 = 3.17522e−06 A 7 = 3.27388e−08 A 9 = 3.39242e−11
A11 = −9.44625e−15 A13 = 2.54975e−18 A15 = 2.37910e−21
3rd Surface
K = 0.00000e+00 A 4 = 1.01288e−06 A 6 = 8.30390e−07 A 8 = 9.93911e−09
A10 = −5.85579e−12 A12 = −6.6513le−14 A14 = 9.14279e−17 A16 = 3.1513le−20
A 3 = 1.30888e−05 A 5 = −3.36283e−06 A 7 = −1.17418e−07 A 9 = −4.14549e−10
A11 = 1.59809e−12 A13 = −5.24135e−17 A15 = −2.93989e−18
10th Surface
K = −3.43995e+00 A 4 = 4.17249e−06 A 6 = −2.91552e−08 A 8 = −1.01820e−10
A10 = 7.78074e−14 A12 = −5.50285e−16 A14 = −3.48381e−19 A16 = 1.69044e−23
A 3 = 4.25353e−06 A 5 = 2.43307e−07 A 7 = 2.28900e−09 A 9 = 8.85240e−13
A11 = 2.84191e−15 A13 = 2.29147e−17 A15 = 2.13039e−22
32nd Surface
K = 1.12407e−03 A 4 = −3.94468e−06 A 6 = 1.24411e−07 A 8−1.26096e−10
A 3 = −8.30887e−06 A 5 = −1.09517e−06 A 7 = −6.28430e−09
VARIOUS DATA

| ZOOM RATIO | 4.11 | | |
|---|---|---|---|
| | WIDE | MIDDLE | TELE |
| Focal Length | 11.20 | 22.70 | 45.99 |
| Fno | 2.73 | 2.72 | 3.66 |
| Half Angle of View (°) | 52.88 | 33.11 | 17.84 |
| Image Height | 14.80 | 14.80 | 14.80 |
| Overall Lens Length | 295.37 | 295.37 | 295.37 |
| BF | 37.99 | 37.99 | 37.99 |
| d18 | 0.97 | 20.64 | 32.19 |
| d25 | 17.36 | 2.98 | 5.09 |
| d30 | 19.93 | 14.64 | 0.98 |

LENS UNIT DATA

| Lens Unit | Starting Surface | Focal Length |
|---|---|---|
| 1 | 1 | 20.95 |
| 2 | 19 | −39.71 |
| 3 | 26 | −40.78 |
| 4 | 31 | 46.52 |

### Numerical Example 5

UNIT: mm
SURFACE DATA

| Surface No. | r | d | nd | vd |
|---|---|---|---|---|
| 1* | ∞ | 2.10 | 1.83481 | 42.7 |
| 2 | 26.064 | 14.43 | | |
| 3* | 99.261 | 1.50 | 1.80400 | 46.5 |
| 4 | 33.614 | 15.30 | | |
| 5 | −43.024 | 1.40 | 1.89190 | 37.1 |
| 6 | −112.144 | 0.11 | | |
| 7 | 175.826 | 8.54 | 1.80810 | 22.8 |
| 8 | −69.511 | 1.44 | | |
| 9 | −274.515 | 7.63 | 1.49700 | 81.5 |
| 10* | −48.322 | 3.55 | | |
| 11 | −1075.998 | 10.51 | 1.48749 | 70.2 |
| 12 | −38.574 | 1.75 | 2.00100 | 29.1 |
| 13 | −67.496 | 0.21 | | |
| 14 | 282.316 | 1.70 | 2.00100 | 29.1 |
| 15 | 62.592 | 15.42 | 1.43875 | 94.7 |
| 16 | −54.962 | 0.19 | | |
| 17 | 2653.660 | 7.92 | 1.76385 | 48.5 |
| 18 | −71.062 | (Variable) | | |
| 19* | 191.478 | 1.20 | 1.83481 | 42.7 |
| 20 | 28.027 | 3.99 | | |
| 21 | −283.148 | 0.82 | 1.83481 | 42.7 |
| 22 | 22.803 | 6.63 | 1.78880 | 28.4 |
| 23 | −68.546 | (Variable) | | |
| 24 | −34.253 | 0.82 | 1.88300 | 40.8 |
| 25 | −90.006 | (Variable) | | |
| 26 | −36.238 | 0.85 | 1.59522 | 67.7 |
| 27 | 54.863 | 2.45 | 1.85478 | 24.8 |
| 28 | 134.425 | (Variable) | | |
| 29* | 50.041 | 4.28 | 1.85150 | 40.8 |
| 30 | −214.006 | (Variable) | | |
| 31 (SP) | ∞ | 1.78 | | |
| 32 | 36.649 | 7.76 | 1.51742 | 52.4 |
| 33 | −126.244 | 0.23 | | |
| 34 | 395.014 | 1.00 | 2.00100 | 29.1 |
| 35 | 31.543 | 5.81 | 1.51633 | 64.1 |
| 36 | −464.533 | 0.41 | | |
| 37 | 550.314 | 6.32 | 1.67270 | 32.1 |
| 38 | −28.473 | 1.00 | 2.00100 | 29.1 |
| 39 | −78.321 | 41.40 | | |
| 40 | 90.435 | 4.78 | 1.43875 | 94.7 |
| 41 | −64.730 | 0.69 | | |
| 42 | 57.600 | 8.05 | 1.80809 | 22.7 |
| 43 | −32.651 | 1.09 | 1.89190 | 37.1 |
| 44 | 32.931 | 0.70 | | |
| 45 | 30.638 | 12.19 | 1.43875 | 94.7 |
| 46 | −21.686 | 1.08 | 2.00100 | 29.1 |
| 47 | 324.070 | 0.13 | | |
| 48 | 64.563 | 9.83 | 1.48749 | 70.2 |
| 49 | −29.650 | 42.78 | | |
| Image Plane | ∞ | | | |

ASPHERIC DATA
1st Surface
K = 0.00000e+00 A 4 = 2.12211e−05 A 6 = 2.92747e−08 A 8 = 3.16369e−11
A10 = −1.92722e−13 A12 = −1.71481e−16 A14 = −3.33400e−19 A16 = −4.37434e−23
A 3 = −5.79764e−05 A 5 = −8.99814e−07 A 7 = −1.23840e−09 A 9 = 2.02850e−12
A11 = 6.28310e−15 A13 = 8.71668e−18 A15 = 6.17837e−21
3rd Surface
K = 0.00000e+00 A 4 = −1.79110e−05 A 6 = 1.11375e−07 A 8 = 2.62789e−09
A10 = −2.66313e−10 A12 = −1.84190e−12 A14 = −1.97779e−15 A16 = −1.91116e−19
A 3 = 4.38754e−05 A 5 = 1.49389e−06 A 7 = −5.31826e−08 A 9 = 1.16762e−09
A11 = 2.84275e−11 A13 = 7.62336e−14 A15 = 2.93897e−17
10th Surface
K = 0.00000e+00 A 4 = −1.92976e−06 A 6 = −2.03689e−07 A 8 = −1.53666e−09
A10 = 5.07998e−12 A12 = 2.24283e−14 A14 = 1.18243e−18 A16 = −1.80400e−21
A 3 = 8.88433e−06 A 5 = 1.13723e−06 A 7 = 2.32798e−08 A 9 = 2.54606e−11
A11 = −5.07035e−13 A13 = −4.72942e−16 A15 = 1.34791e−19
19th Surface
K = 0.00000e+00 A 4 = 5.11909e−06 A 6 = 9.82184e−07 A 8 = 6.17276e−08
A10 = −8.92220e−10 A12 = −2.54383e−11 A14 = −7.19649e−14 A16 = −1.75358e−17
A 3 = 1.93551e−06 A 5 = −1.25952e−06 A 7 = −3.51791e−07 A 9 = −3.13215e−09
A11 = 2.23517e−10 A13 = 1.72911e−12 A15 = 1.70029e−15
29th Surface
K = 0.00000e+00 A 4 = −8.69389e−06 A 6 = −4.59870e−07 A 8 = −5.52191e−09
A10 = 3.37450e−12 A12 = 6.59970e−14 A14 = 1.13614e−16 A16 = −1.95539e−21
A 3 = 2.83601e−06 A 5 = 1.82880e−06 A 7 = 6.72368e−08 A 9 = 2.08662e−10
A11 = −8.86327e−13 A13 = −3.47365e−15 A15 = −1.55784e−18
VARIOUS DATA

| ZOOM RATIO | 4.76 | | |
|---|---|---|---|
| | WIDE | MIDDLE | TELE |
| Focal Length | 10.50 | 22.91 | 49.99 |
| Fno | 2.99 | 3.00 | 3.98 |
| Half Angle of View (°) | 54.65 | 32.86 | 16.49 |
| Image Height | 14.80 | 14.80 | 14.80 |
| Overall Lens Length | 319.84 | 319.84 | 319.84 |
| BF | 42.78 | 42.78 | 42.78 |
| d18 | 1.26 | 30.26 | 49.27 |
| d23 | 5.39 | 1.52 | 3.13 |
| d25 | 27.06 | 7.74 | 3.76 |
| d28 | 4.03 | 5.77 | 0.34 |
| d30 | 20.34 | 12.79 | 1.59 |

LENS UNIT DATA

| Lens Unit | Starting Surface | Focal Length |
|---|---|---|
| 1 | 1 | 25.29 |
| 2 | 19 | −59.81 |
| 3 | 24 | −63.06 |
| 4 | 26 | −55.05 |
| 5 | 29 | 47.99 |
| 6 | 31 | 76.15 |

### Numerical Example 6

UNIT: mm
SURFACE DATA

| Surface No. | r | d | nd | vd |
|---|---|---|---|---|
| 1* | 158.339 | 2.40 | 1.76385 | 48.5 |
| 2 | 26.149 | 16.26 | | |
| 3 | 98.808 | 1.60 | 2.00100 | 29.1 |
| 4 | 29.788 | 17.43 | | |
| 5 | −31.955 | 1.50 | 1.88300 | 40.8 |
| 6 | −47.052 | 1.88 | | |
| 7 | 290.590 | 5.87 | 1.89286 | 20.4 |
| 8 | −108.119 | 1.50 | | |
| 9 | 82.067 | 10.75 | 1.61800 | 63.3 |
| 10* | −68.506 | 6.10 | | |
| 11 | −4155.712 | 5.81 | 1.49700 | 81.5 |
| 12 | −66.925 | 0.20 | | |
| 13 | −64.491 | 1.80 | 1.76385 | 48.5 |
| 14 | −59.861 | 0.20 | | |
| 15 | −65.245 | 1.65 | 1.95375 | 32.3 |
| 16 | 51.828 | 11.82 | 1.43875 | 94.9 |
| 17 | −44.109 | 0.20 | | |
| 18 | 138.884 | 6.10 | 1.76385 | 48.5 |
| 19 | −84.859 | (Variable) | | |
| 20* | 2592.723 | 1.20 | 1.90525 | 35.0 |
| 21 | 33.764 | 3.72 | | |
| 22 | −101.320 | 0.80 | 1.59522 | 67.7 |
| 23 | 68.653 | 3.53 | 1.85478 | 24.8 |
| 24 | −52.494 | 0.97 | | |
| 25 | −31.663 | 0.80 | 1.76385 | 48.5 |
| 26 | −106.993 | (Variable) | | |
| 27 | −54.981 | 0.80 | 1.60300 | 65.4 |
| 28 | 41.685 | 2.10 | 1.85478 | 24.8 |
| 29 | 79.385 | (Variable) | | |
| 30 (SP) | ∞ | 1.00 | | |
| 31* | 27.319 | 6.83 | 1.58144 | 40.8 |
| 32 | −96.058 | 0.20 | | |
| 33 | 51.988 | 5.61 | 1.78472 | 25.7 |
| 34 | −53.308 | 0.90 | 2.00069 | 25.5 |
| 35 | 36.481 | (Variable) | | |
| 36 | 205.721 | 2.98 | 1.56732 | 42.8 |
| 37 | −90.051 | 0.20 | | |
| 38 | 52.560 | 1.00 | 2.05090 | 26.9 |
| 39 | 30.878 | 3.82 | 1.53775 | 74.7 |
| 40 | 139.636 | 40.06 | | |
| 41 | 65.300 | 7.10 | 1.55200 | 70.7 |
| 42 | −63.226 | 0.40 | | |
| 43 | 53.865 | 6.23 | 1.80810 | 22.8 |
| 44 | −87.935 | 1.10 | 1.88300 | 40.8 |
| 45 | 27.056 | 1.30 | | |
| 46 | 25.986 | 13.14 | 1.43875 | 94.7 |
| 47 | −25.415 | 1.50 | 2.05090 | 26.9 |
| 48 | 450.763 | 2.45 | | |
| 49 | 64.014 | 8.57 | 1.48749 | 70.2 |
| 50 | −40.768 | 38.21 | | |
| Image Plane | ∞ | | | |

ASPHERIC DATA
1st Surface
K = 0.00000e+00 A 4 = 6.66512e−06 A 6 = −6.63901e−09 A 8 = 7.94299e−12
A10 = −6.37720e−15 A12 = 3.24442e−18 A14 = −8.73462e−22 A16 = 9.75612e−26
10th Surface
K = 0.00000e+00 A 4 = 2.21622e−06 A 6 = −8.91734e−10 A 8 = 1.91386e−13
20th Surface
K = 0.00000e+00 A 4 = 4.49580e−06 A 6 = −1.08843e−08 A 8 = 1.64151e−10
A10 = −1.12739e−12 A12 = 2.82068e−15
31 st Surface
K = 0.00000e+00 A 4 = −9.58966e−06 A 6 = −2.12938e−10 A 8 = −7.66613e−12
VARIOUS DATA

| ZOOM RATIO | 4.29 | | |
|---|---|---|---|
| | WIDE | MIDDLE | TELE |
| Focal Length | 10.50 | 21.74 | 45.00 |
| Fno | 2.90 | 2.90 | 3.86 |
| Half Angle of View (°) | 54.65 | 34.25 | 18.21 |
| Image Height | 14.80 | 14.80 | 14.80 |
| Overall Lens Length | 305.00 | 305.00 | 305.00 |
| BF | 38.21 | 38.21 | 38.21 |
| d19 | 1.00 | 27.32 | 45.12 |
| d26 | 25.73 | 5.10 | 5.30 |
| d29 | 10.13 | 10.47 | 1.00 |
| d35 | 18.58 | 12.55 | 4.01 |

LENS UNIT DATA

| Lens Unit | Starting Surface | Focal Length |
|---|---|---|
| 1 | 1 | 26.17 |
| 2 | 20 | −33.84 |
| 3 | 27 | −63.37 |
| 4 | 30 | 60.82 |
| 5 | 36 | 63.21 |

### Numerical Example 7

UNIT: mm
SURFACE DATA

| Surface No. | r | d | nd | vd |
|---|---|---|---|---|
| 1* | 350.864 | 2.40 | 1.76385 | 48.5 |
| 2 | 25.537 | 17.03 | | |
| 3 | 134.403 | 1.60 | 2.00100 | 29.1 |
| 4 | 30.378 | 17.97 | | |
| 5 | −28.502 | 1.50 | 1.88300 | 40.8 |
| 6 | −38.150 | 0.20 | | |
| 7 | 346.737 | 5.98 | 1.89286 | 20.4 |
| 8 | −99.139 | 6.87 | | |
| 9 | 56.481 | 10.65 | 1.61800 | 63.3 |
| 10* | −143.091 | 3.20 | | |
| 11 | −574.247 | 6.84 | 1.49700 | 81.5 |
| 12 | −67.366 | 0.20 | | |
| 13 | −90.441 | 1.80 | 1.76385 | 48.5 |
| 14 | −78.944 | 0.20 | | |
| 15 | −117.593 | 1.65 | 1.95375 | 32.3 |
| 16 | 42.108 | 12.56 | 1.43875 | 94.9 |
| 17 | −64.471 | 0.20 | | |
| 18 | 193.247 | 6.41 | 1.76385 | 48.5 |
| 19 | −80.389 | (Variable) | | |
| 20* | 281.571 | 1.20 | 1.90525 | 35.0 |
| 21 | 37.339 | 3.96 | | |
| 22 | −218.752 | 0.80 | 1.59522 | 67.7 |
| 23 | 50.820 | 3.89 | 1.85478 | 24.8 |
| 24 | −106.921 | (Variable) | | |
| 25 | −32.651 | 0.80 | 1.76385 | 48.5 |
| 26 | −73.269 | (Variable) | | |
| 27 | −60.566 | 0.80 | 1.60300 | 65.4 |
| 28 | 36.843 | 2.21 | 1.85478 | 24.8 |
| 29 | 64.596 | (Variable) | | |
| 30 (SP) | ∞ | 1.00 | | |
| 31* | 26.184 | 7.54 | 1.58144 | 40.8 |
| 32 | −76.659 | 0.20 | | |
| 33 | 72.527 | 6.65 | 1.78472 | 25.7 |
| 34 | −30.818 | 0.90 | 2.00069 | 25.5 |
| 35 | 42.789 | (Variable) | | |
| 36 | 114.623 | 5.01 | 1.56732 | 42.8 |
| 37 | −59.726 | 0.20 | | |
| 38 | 35.394 | 1.00 | 2.05090 | 26.9 |
| 39 | 23.101 | 3.11 | 1.53775 | 74.7 |
| 40 | 37.927 | 40.06 | | |
| 41 | 44.767 | 10.08 | 1.55200 | 70.7 |
| 42 | −68.744 | 0.40 | | |
| 43 | 70.859 | 6.39 | 1.80810 | 22.8 |
| 44 | −57.109 | 1.10 | 1.88300 | 40.8 |
| 45 | 30.515 | 1.30 | | |
| 46 | 36.659 | 12.38 | 1.43875 | 94.7 |
| 47 | −21.039 | 1.50 | 2.05090 | 26.9 |
| 48 | −184.013 | 0.93 | | |
| 49 | 177.920 | 8.91 | 1.48749 | 70.2 |
| 50 | −28.747 | 37.00 | | |
| Image Plane | ∞ | | | |

ASPHERIC DATA
1st Surface
K = 0.00000e+00 A 4 = 9.27537e−06 A 6 = −1.12171e−08 A 8 = 1.42929e−11
A10 = −1.25541e−14 A12 = 6.9743le−18 A14 = −2.1186le−21 A16 = 2.69883e−25
10th Surface
K = 0.00000e+00 A 4 = 2.51032e−06 A 6 = −6.65025e−10 A 8 = 3.23129e−13
20th Surface
K = 0.00000e+00 A 4 = 3.82368e−06 A 6 = −7.36056e−09 A 8 = 9.10597e−11
A10 = −4.40990e−13 A12 = 7.80182e−16
31st Surface
K = 0.00000e+00 A 4 = −1.02901e−05 A 6 = 6.69079e−11 A 8 = −7.4743le−12
VARIOUS DATA

| ZOOM RATIO | 4.20 | | |
|---|---|---|---|
| | WIDE | MIDDLE | TELE |
| Focal Length | 10.00 | 20.49 | 42.00 |
| Fno | 2.90 | 2.90 | 3.83 |
| Half Angle of View (°) | 55.95 | 35.84 | 19.41 |
| Image Height | 14.80 | 14.80 | 14.80 |
| Overall Lens Length | 319.50 | 319.50 | 319.50 |
| BF | 37.00 | 37.00 | 37.00 |
| d19 | 1.00 | 31.12 | 51.87 |
| d24 | 3.00 | 3.57 | 3.96 |
| d26 | 32.37 | 7.43 | 3.93 |
| d29 | 9.44 | 9.52 | 1.00 |
| d35 | 17.13 | 11.30 | 2.18 |

LENS UNIT DATA

| Lens Unit | Starting Surface | Focal Length |
|---|---|---|
| 1 | 1 | 27.54 |
| 2 | 20 | −107.60 |
| 3 | 25 | −77.77 |
| 4 | 27 | −60.84 |
| 5 | 30 | 61.28 |
| 6 | 36 | 64.59 |

### Numerical Example 8

UNIT: mm
SURFACE DATA

| Surface No. | r | d | nd | vd |
|---|---|---|---|---|
| 1* | 165.643 | 2.40 | 1.76385 | 48.5 |
| 2 | 26.247 | 16.07 | | |
| 3 | 91.382 | 1.60 | 2.00100 | 29.1 |
| 4 | 30.125 | 17.05 | | |
| 5 | −33.996 | 1.50 | 1.88300 | 40.8 |
| 6 | −55.220 | 1.44 | | |
| 7 | 298.799 | 6.48 | 1.89286 | 20.4 |
| 8 | −101.097 | 3.56 | | |
| 9 | 78.821 | 10.83 | 1.61800 | 63.3 |
| 10* | −69.014 | 6.77 | | |
| 11 | −231.617 | 5.39 | 1.49700 | 81.5 |
| 12 | −62.833 | 0.20 | | |
| 13 | −64.046 | 1.80 | 1.76385 | 48.5 |
| 14 | −59.505 | 0.20 | | |
| 15 | −65.336 | 1.65 | 1.95375 | 32.3 |
| 16 | 51.877 | 11.39 | 1.43875 | 94.9 |
| 17 | −48.570 | (Variable) | | |
| 18 | 135.062 | 6.74 | 1.76385 | 48.5 |
| 19 | −74.542 | (Variable) | | |
| 20* | 240.387 | 1.20 | 1.90525 | 35.0 |
| 21 | 31.834 | 3.95 | | |
| 22 | −110.534 | 0.80 | 1.59522 | 67.7 |
| 23 | 57.055 | 3.49 | 1.85478 | 24.8 |
| 24 | −72.545 | 1.20 | | |
| 25 | −33.861 | 0.80 | 1.76385 | 48.5 |
| 26 | −92.926 | (Variable) | | |
| 27 | −54.081 | 0.80 | 1.60300 | 65.4 |
| 28 | 47.402 | 2.04 | 1.85478 | 24.8 |
| 29 | 92.243 | (Variable) | | |
| 30 (SP) | ∞ | 1.00 | | |
| 31* | 32.147 | 6.56 | 1.58144 | 40.8 |
| 32 | −83.684 | 0.20 | | |
| 33 | 60.222 | 6.98 | 1.78472 | 25.7 |
| 34 | −47.389 | 0.90 | 2.00069 | 25.5 |
| 35 | 46.808 | (Variable) | | |
| 36 | 158.561 | 2.93 | 1.56732 | 42.8 |
| 37 | −121.891 | 0.20 | | |
| 38 | 53.973 | 1.00 | 2.05090 | 26.9 |
| 39 | 29.777 | 4.26 | 1.53775 | 74.7 |
| 40 | 189.562 | 40.06 | | |
| 41 | 77.349 | 6.94 | 1.55200 | 70.7 |
| 42 | −57.716 | 0.40 | | |
| 43 | 51.292 | 6.53 | 1.80810 | 22.8 |
| 44 | −79.357 | 1.10 | 1.88300 | 40.8 |
| 45 | 26.363 | 1.30 | | |
| 46 | 25.239 | 12.90 | 1.43875 | 94.7 |
| 47 | −25.868 | 1.50 | 2.05090 | 26.9 |
| 48 | 285.606 | 3.86 | | |
| 49 | 63.506 | 8.48 | 1.48749 | 70.2 |
| 50 | −41.835 | 37.00 | | |
| Image Plane | ∞ | | | |

ASPHERIC DATA
1st Surface
K = 0.00000e+00 A 4 = 6.51517e−06 A 6 = −6.50746e−09 A 8 = 7.68974e−12
A10 = −6.01137e−15 A12 = 2.85409e−18 A14 = −6.6460le−22 A16 = 5.25588e−26
10th Surface
K = 0.00000e+00 A 4 = 2.33473e−06 A 6 = −8.80364e−10 A 8 = 1.83146e−13
20th Surface
K = 0.00000e+00 A 4 = 3.68428e−06 A 6 = −9.78901e−09 A 8 = 1.36129e−10
A10 = −8.57822e−13 A12 = 2.01401e−15
31st Surface
K = 0.00000e+00 A 4 = −6.79151e−06 A 6 = 9.62450e−10 A 8 = −3.51924e−12
VARIOUS DATA

| ZOOM RATIO | 4.29 | | |
|---|---|---|---|
| | WIDE | MIDDLE | TELE |
| Focal Length | 10.50 | 21.74 | 45.00 |
| Fno | 2.90 | 2.90 | 3.88 |
| Half Angle of View (°) | 54.65 | 34.25 | 18.20 |
| Image Height | 14.80 | 14.80 | 14.80 |
| Overall Lens Length | 315.00 | 315.00 | 315.00 |
| BF | 37.00 | 37.00 | 37.00 |
| d17 | 0.20 | 0.80 | 1.20 |
| d19 | 1.00 | 28.74 | 47.54 |
| d26 | 27.74 | 5.48 | 5.11 |
| d29 | 10.94 | 11.25 | 1.00 |
| d35 | 21.68 | 15.28 | 6.70 |

LENS UNIT DATA

| Lens Unit | Starting Surface | Focal Length |
|---|---|---|
| 1 | 1 | −56.39 |
| 2 | 18 | 63.77 |
| 3 | 20 | −35.13 |
| 4 | 27 | −65.85 |
| 5 | 30 | 60.03 |
| 6 | 36 | 67.49 |

### Numerical Example 9

UNIT: mm
SURFACE DATA

| Surface No. | r | d | nd | vd |
|---|---|---|---|---|
| 1* | −136.222 | 2.40 | 1.76385 | 48.5 |
| 2 | 26.189 | 13.28 | | |
| 3 | 54.337 | 1.60 | 2.00100 | 29.1 |
| 4 | 28.256 | 18.44 | | |
| 5 | −33.251 | 1.50 | 1.88300 | 40.8 |
| 6 | −66.547 | 0.20 | | |
| 7 | 1222.224 | 6.25 | 1.89286 | 20.4 |
| 8 | −78.167 | 7.12 | | |
| 9 | 69.770 | 10.70 | 1.61800 | 63.3 |
| 10* | −103.132 | 3.88 | | |
| 11 | 232.726 | 9.27 | 1.49700 | 81.5 |
| 12 | −63.103 | 0.20 | | |
| 13 | −81.310 | 1.80 | 1.76385 | 48.5 |
| 14 | −73.135 | 0.20 | | |
| 15 | −102.222 | 1.65 | 1.95375 | 32.3 |
| 16 | 45.873 | 10.59 | 1.43875 | 94.9 |
| 17 | −106.650 | 0.20 | | |
| 18 | 139.851 | 7.73 | 1.76385 | 48.5 |
| 19 | −70.546 | (Variable) | | |
| 20* | 225.861 | 1.20 | 1.90525 | 35.0 |
| 21 | 27.807 | 3.70 | | |
| 22 | 203.080 | 0.80 | 1.59522 | 67.7 |
| 23 | 94.954 | 3.45 | 1.85478 | 24.8 |
| 24 | −61.715 | 1.50 | | |
| 25 | −30.177 | 0.80 | 1.76385 | 48.5 |
| 26 | −81.962 | (Variable) | | |
| 27 | −27.949 | 0.80 | 1.60300 | 65.4 |
| 28 | 29.305 | 2.42 | 1.85478 | 24.8 |
| 29 | 54.725 | (Variable) | | |
| 30 (SP) | ∞ | 0.99 | | |
| 31* | 36.277 | 6.52 | 1.58144 | 40.8 |
| 32 | −53.839 | 0.20 | | |
| 33 | 35.053 | 10.41 | 1.78472 | 25.7 |
| 34 | −22.983 | 0.90 | 2.00069 | 25.5 |
| 35 | 44.535 | (Variable) | | |
| 36 | 80.796 | 3.55 | 1.56732 | 42.8 |
| 37 | −76.345 | 0.20 | | |
| 38 | 102.310 | 1.00 | 2.05090 | 26.9 |
| 39 | 26.728 | 5.01 | 1.53775 | 74.7 |
| 40 | −132.946 | 40.05 | | |
| 41 | 70.290 | 9.84 | 1.55200 | 70.7 |
| 42 | −53.403 | 0.40 | | |
| 43 | 82.202 | 7.09 | 1.80810 | 22.8 |
| 44 | −43.181 | 1.10 | 1.88300 | 40.8 |
| 45 | 32.882 | 1.29 | | |
| 46 | 36.837 | 12.93 | 1.43875 | 94.7 |
| 47 | −21.611 | 1.50 | 2.05090 | 26.9 |
| 48 | −97.493 | 0.20 | | |
| 49 | 2759.380 | 8.59 | 1.48749 | 70.2 |
| 50 | −28.183 | 36.97 | | |
| Image Plane | ∞ | | | |

ASPHERIC DATA
1st Surface
K = 0.00000e+00 A 4 = 1.48127e−05 A 6 = −2.03754e−08 A 8 = 2.39046e−11
A10 = −1.95154e−14 A12 = 1.01413e−17 A14 = −2.97641e−21 A16 = 3.74129e−25
10th Surface
K = 0.00000e+00 A 4 = 3.18927e−06 A 6 = −4.99601e−10 A 8 = 1.20063e−13
20th Surface
K = 0.00000e+00 A 4 = 9.11689e−06 A 6 = −2.67545e−08 A 8 = 2.34853e−10
A10 = −9.60572e−13 A12 = 1.62212e−15
31 st Surface
K = 0.00000e+00 A 4 = −4.86756e−06 A 6 = 1.16575e−08 A 8 = 1.59033e−12
VARIOUS DATA

| ZOOM RATIO | 4.65 | | |
|---|---|---|---|
| | WIDE | MIDDLE | TELE |
| Focal Length | 8.60 | 18.55 | 40.00 |
| Fno | 2.90 | 2.90 | 3.62 |
| Half Angle of View (°) | 59.84 | 38.59 | 20.31 |
| Image Height | 14.80 | 14.80 | 14.80 |
| Overall Lens Length | 319.52 | 319.52 | 319.52 |
| BF | 36.97 | 36.97 | 36.97 |
| d19 | 0.99 | 31.47 | 52.22 |
| d26 | 31.78 | 8.79 | 4.04 |
| d29 | 6.42 | 6.01 | 0.99 |
| d35 | 19.90 | 12.83 | 1.85 |

LENS UNIT DATA

| Lens Unit | Starting Surface | Focal Length |
|---|---|---|
| 1 | 1 | 24.86 |
| 2 | 20 | −40.56 |
| 3 | 27 | −34.55 |
| 4 | 30 | 37.83 |
| 5 | 36 | 64.01 |

TABLE 1

| | | Numerical Example | | | | |
|---|---|---|---|---|---|---|
| Inequality | | 1 | 2 | 3 | 4 | 5 |
| 1 | fw/TL | 0.0313 | 0.0346 | 0.0344 | 0.0379 | 0.0328 |
| 2 | fl/TL | 0.0722 | 0.0814 | 0.0852 | 0.0709 | 0.0791 |
| 3 | ft/fw | 4.201 | 4.091 | 5.000 | 4.106 | 4.761 |
| 4 | βr | −1.893 | −1.710 | −1.805 | −1.415 | −2.159 |
| 1′ | fw/TL | 0.0313 | 0.0346 | 0.0344 | 0.0379 | 0.0328 |
| 2′ | fl/TL | 0.0722 | 0.0814 | 0.0852 | 0.0709 | 0.0791 |
| 3′ | ft/fw | 4.201 | 4.091 | 5.000 | 4.106 | 4.761 |
| 5 | fl/fv | −0.62 | −0.64 | −0.76 | −0.53 | −0.95 |
| 6 | fl1/fl | −1.06 | −0.98 | −0.91 | −0.72 | −0.95 |
| 7 | fl2/fl | 4.58 | 4.76 | 3.56 | 3.44 | 4.61 |
| 8 | fl3/fl | 2.77 | 2.44 | 2.25 | 2.02 | 2.53 |
| 9 | LD1/fl | 4.07 | 3.55 | 3.27 | 3.83 | 3.70 |
| 10 | ωw | 55.95 | 53.38 | 53.38 | 52.88 | 54.65 |
| 11 | Fnow | 2.72 | 2.72 | 2.72 | 2.73 | 2.99 |
| 12 | fw/BFw | 0.246 | 0.275 | 0.280 | 0.295 | 0.245 |
| 13 | LDs/TL | 0.53 | 0.53 | 0.53 | 0.47 | 0.54 |
| 14 | (fl + bok1)/fl | 4.000 | 3.689 | 3.310 | 3.286 | 3.587 |
| 15 | ft/fl | 1.821 | 1.739 | 2.021 | 2.195 | 1.977 |
| 16 | fl/fw | 2.307 | 2.353 | 2.474 | 1.871 | 2.408 |
| | fw | 10.000 | 11.000 | 11.000 | 11.200 | 10.500 |
| | ft | 42.008 | 45.000 | 54.997 | 45.989 | 49.995 |
| | fl | 23.069 | 25.882 | 27.218 | 20.954 | 25.286 |
| | TL | 319.552 | 318.021 | 319.513 | 295.370 | 319.838 |
| | βr | −1.893 | −1.710 | −1.805 | −1.415 | −2.159 |
| | fv | −37.027 | −40.340 | −35.937 | −39.712 | −26.659 |
| | fl1 | −24.493 | −25.421 | −24.772 | −15.039 | −24.108 |
| | fl2 | 105.580 | 123.154 | 96.980 | 72.081 | 116.693 |
| | fl3 | 63.888 | 63.136 | 61.117 | 42.334 | 63.977 |
| | LD1 | 93.793 | 91.778 | 89.137 | 80.247 | 93.682 |
| | ωw | 55.954 | 53.379 | 53.379 | 52.883 | 54.646 |
| | Y | 14.800 | 14.800 | 14.800 | 14.800 | 14.800 |
| | Fnow | 2.723 | 2.723 | 2.719 | 2.726 | 2.992 |
| | BFw | 40.588 | 39.989 | 39.342 | 37.987 | 42.785 |
| | LDs | 170.419 | 167.103 | 168.051 | 138.056 | 172.810 |
| | bok1 | 69.211 | 69.593 | 62.860 | 47.903 | 65.408 |

| | | Numerical Example | | | |
|---|---|---|---|---|---|
| Inequality | | 6 | 7 | 8 | 9 |
| 1 | fw/TL | 0.0344 | 0.0313 | 0.0333 | 0.0269 |
| 2 | fl/TL | 0.0858 | 0.0862 | 0.0846 | 0.0778 |
| 3 | ft/fw | 4.286 | 4.200 | 4.286 | 4.651 |
| 4 | βr | −1.481 | −1.468 | −1.473 | −1.941 |
| 1′ | fw/TL | 0.0344 | 0.0313 | 0.0333 | 0.0269 |
| 2′ | fl/TL | 0.0858 | 0.0862 | 0.0846 | 0.0778 |
| 3′ | ft/fw | 4.286 | 4.200 | 4.286 | 4.651 |
| 5 | fl/fv | −0.77 | −0.67 | −0.76 | −0.61 |
| 6 | fl1/fl | −0.85 | −0.74 | −0.83 | −0.71 |
| 7 | fl2/fl | 2.37 | 2.43 | 2.30 | 2.77 |
| 8 | fl3/fl | 3.32 | 3.64 | 3.42 | 3.31 |
| 9 | LD1/fl | 3.56 | 3.53 | 3.58 | 3.90 |
| 10 | ωw | 54.65 | 55.95 | 54.65 | 59.84 |
| 11 | Fnow | 2.90 | 2.90 | 2.90 | 2.90 |
| 12 | fw/BFw | 0.275 | 0.270 | 0.284 | 0.233 |
| 13 | LDs/TL | 0.47 | 0.49 | 0.47 | 0.47 |
| 14 | (fl + bok1)/fl | 3.366 | 3.792 | 3.475 | 3.886 |
| 15 | ft/fl | 1.719 | 1.525 | 1.690 | 1.609 |
| 16 | fl/fw | 2.492 | 2.754 | 2.537 | 2.891 |
| | fw | 10.500 | 10.000 | 10.500 | 8.600 |
| | ft | 45.000 | 42.000 | 45.001 | 39.998 |
| | fl | 26.171 | 27.540 | 26.634 | 24.865 |
| | TL | 305.004 | 319.502 | 315.000 | 319.518 |
| | βr | −1.481 | −1.468 | −1.473 | −1.941 |
| | fv | −33.843 | −41.398 | −35.125 | −40.556 |
| | fl1 | −22.318 | −20.366 | −22.168 | −17.571 |
| | fl2 | 62.110 | 66.891 | 61.255 | 68.970 |
| | fl3 | 86.811 | 100.192 | 91.196 | 82.411 |
| | LD1 | 93.069 | 97.251 | 95.273 | 97.004 |
| | ωw | 54.646 | 55.954 | 54.646 | 59.840 |
| | Y | 14.800 | 14.800 | 14.800 | 14.800 |
| | Fnow | 2.900 | 2.899 | 2.900 | 2.900 |
| | BFw | 38.207 | 36.998 | 36.996 | 36.975 |
| | LDs | 143.837 | 156.710 | 149.236 | 150.872 |
| | bok1 | 61.927 | 76.897 | 65.907 | 71.762 |

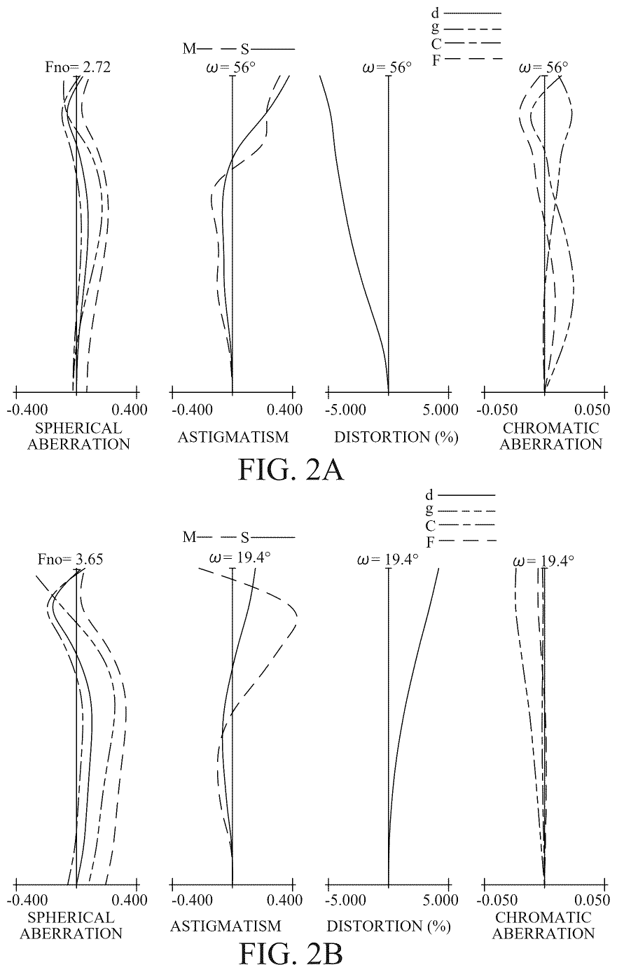

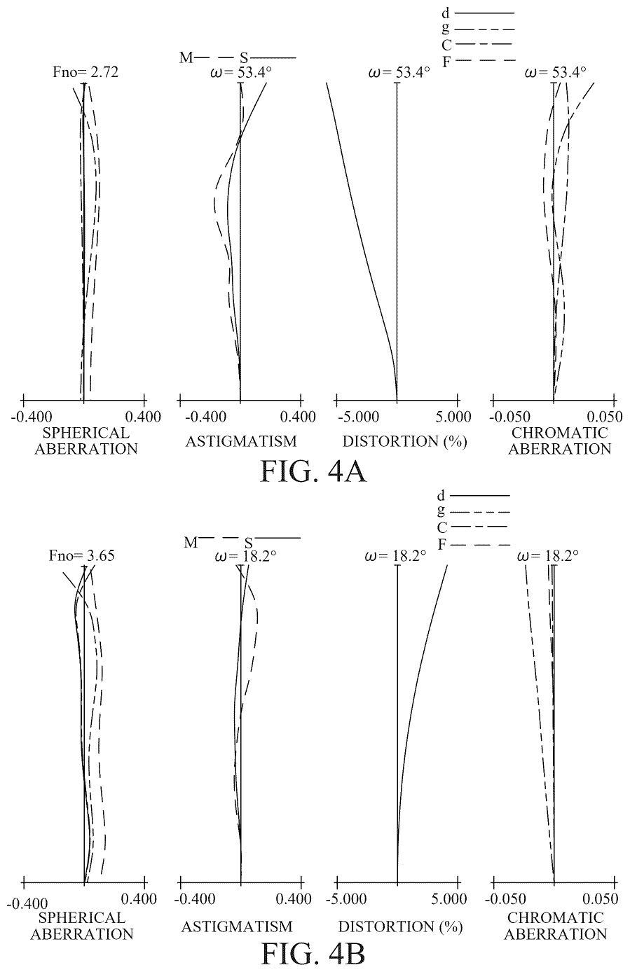

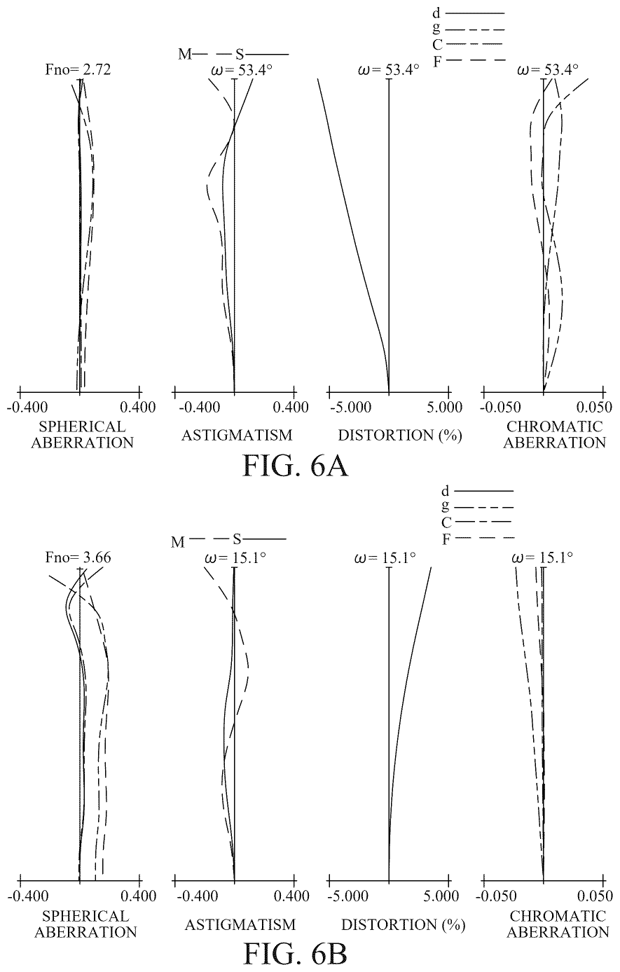

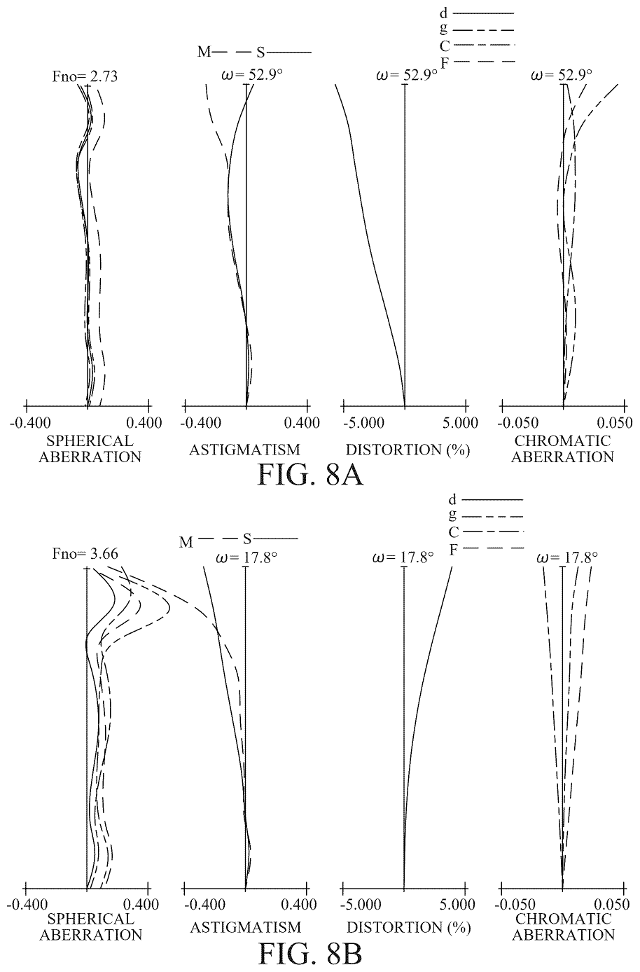

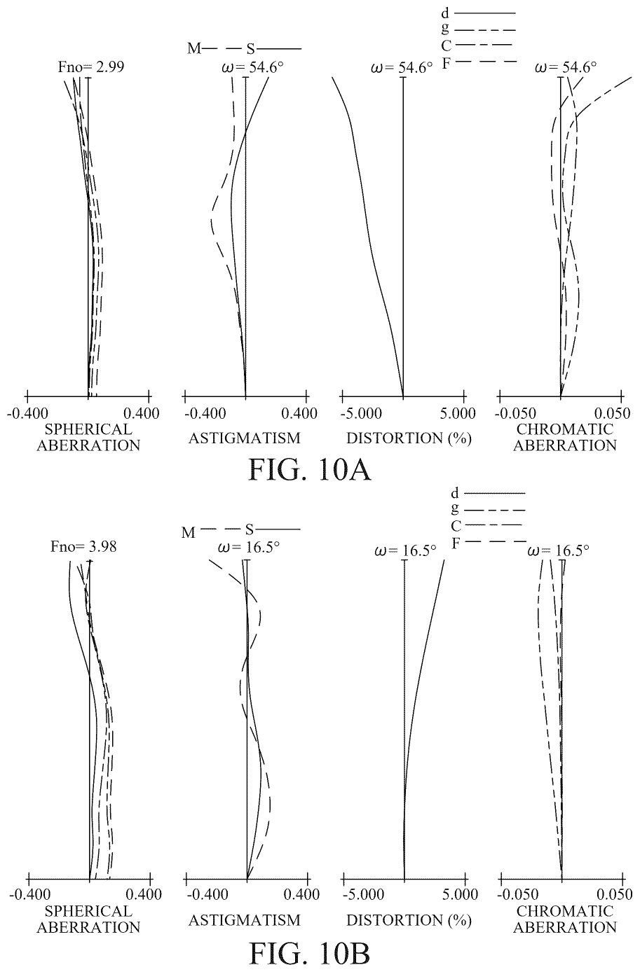

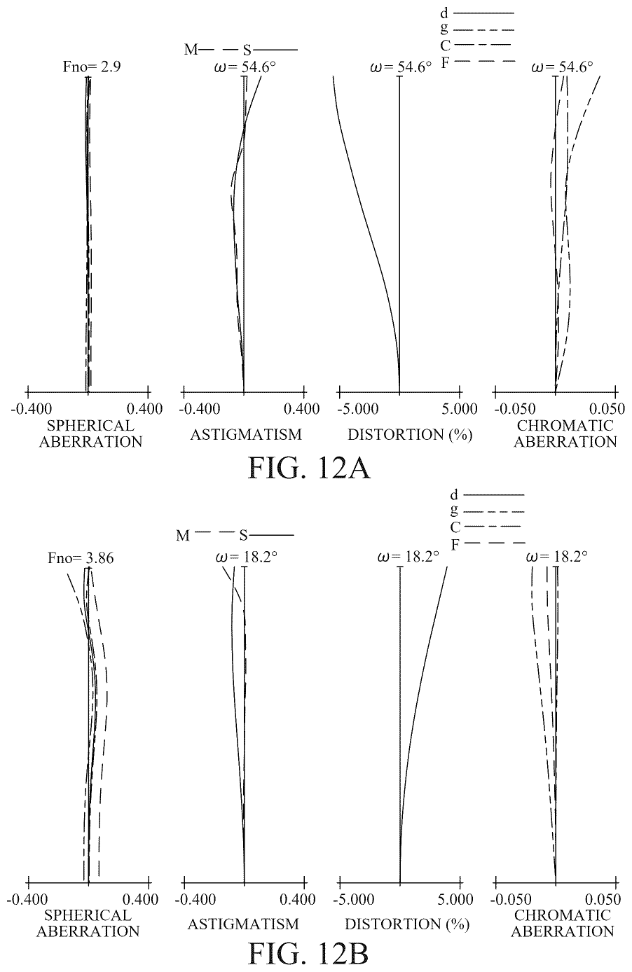

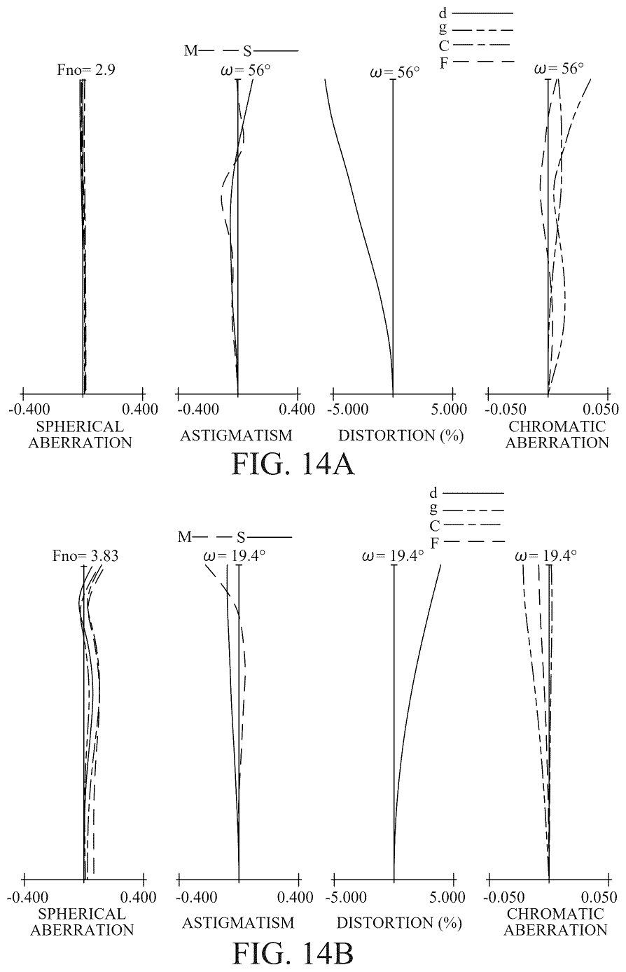

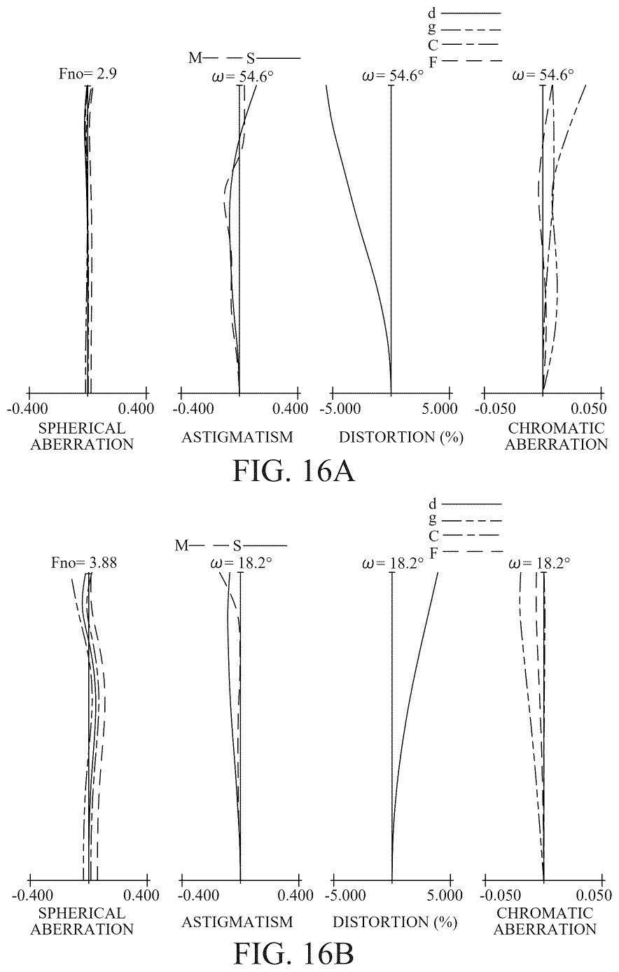

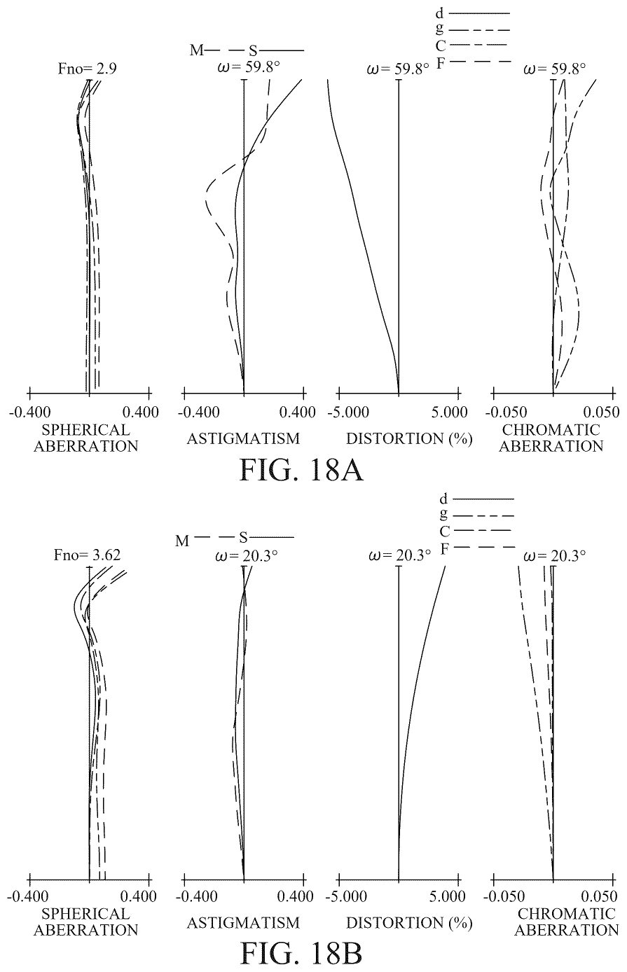

FIGS. 2A, 4A, 6A, 8A, 10A, 12A, 14A, 16A, and 18A respectively illustrate the longitudinal aberrations (spherical aberration, astigmatism, distortion, and chromatic aberration) of the zoom lenses according to numerical examples 1 to 9 in the in-focus state at infinity at the wide-angle end. FIGS. 2B, 4B, 6B, 8B, 10B, 12B, 14B, 16B, and 18B respectively illustrate the longitudinal aberrations of the zoom lenses according to numerical examples 1 to 9 in the in-focus state at infinity at the telephoto end.

In the spherical aberration diagrams, Fno indicates the F-number. A solid line indicates a spherical aberration amount for the d-line (wavelength 587.6 nm), and an alternate long and two short dashes line indicates a spherical aberration amount for the g-line (wavelength 435.8 nm). An alternate long and short dash line indicates a spherical aberration amount for the C-line (wavelength 656.3 nm), and a long-broken line indicates a spherical aberration amount for the F-line (wavelength 486.1 nm). In the astigmatism diagram, a solid line S indicates an astigmatism amount on a sagittal image plane, and a broken line M indicates an astigmatism amount on a meridional image plane. The distortion diagram illustrates a distortion amount for the d-line. The chromatic aberration diagram illustrates lateral chromatic aberration amounts for the g-line, C-line, and F-line.

The astigmatism and chromatic aberration diagrams illustrate the aberration amounts when the central ray of the light beam at the aperture position is used as the principal ray. ω is a paraxial half angle of view (°). The spherical aberration is plotted on a scale of 0.2 mm, the astigmatism on a scale of 0.2 mm, the distortion on a scale of 5%, and the chromatic aberration on a scale of 0.05 mm.

### Image Pickup Apparatus

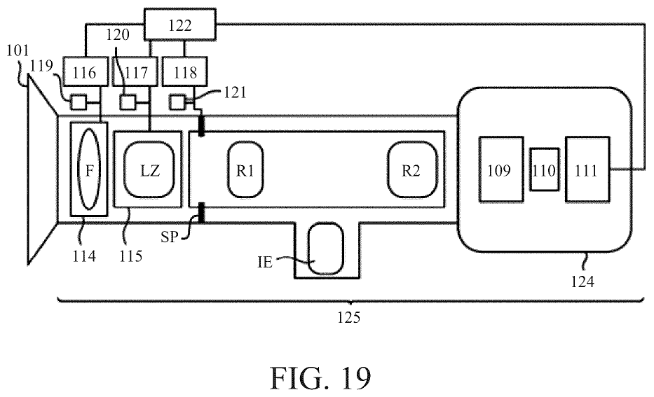

FIG. 19 illustrates an image pickup apparatus (video camera) 125 having a zoom lens 101 according to any one of Examples 1-9. Reference numeral 124 denotes a camera body. The zoom lens 101 is attachable to and detachable from the camera body 124. The zoom lens 101 includes a first lens unit F, an intermediate lens unit LZ including two or more intermediate lens units, and a rear lens unit (R1, R2) for imaging. The first lens unit F includes a first sub-lens unit and a third sub-lens unit that do not move for focusing, and a second sub-lens unit that moves for focusing. SP denotes an aperture stop.

Reference numerals 114 and 115 denote drive mechanisms that drive the second sub-lens unit and the intermediate lens unit LZ in the optical axis direction, respectively. The drive mechanisms include a helicoid, a cam, and other components.

Reference numerals 116 to 118 denote drive units that include motors that drive the drive mechanisms 114 and 115 and the aperture stop SP, respectively. Reference numerals 119 to 121 denote detectors that detect the position on the optical axis of the second sub-lens unit, the position on the optical axis of the intermediate group LZ, and the aperture diameter of the aperture stop SP, respectively. The detectors are configured using an encoder, potentiometer, photosensor, etc.

In the camera body 124, reference numeral 109 denotes a glass block containing an optical filter, etc., and reference numeral 110 denotes an image sensor that captures an object image formed by the zoom lens 101 (the object via the zoom lens). The image sensor includes a photoelectric conversion element, such as a CCD or CMOS sensor.

Reference numerals 111 and 122 denote a camera CPU as a control unit for the camera body 124 and a lens CPU as a control unit for the zoom lens 101, respectively.

The zoom lens according to each example can provide an image pickup apparatus that has a reduced size and weight, and can generate high-quality images with a wide angle of view and a high magnification variation ratio.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a zoom lens having high optical performance.

This application claims the benefit of Japanese Patent Application No. 2025-031666, filed on Feb. 28, 2025, and which is hereby incorporated by reference herein in its entirety.

What is claimed is:

1. A zoom lens comprising, in order from an object side to an image side:
a first lens unit with positive refractive power that does not move for zooming;
an intermediate group having two or more lens units that move for zooming; and
a rear lens unit,
wherein the zoom lens further comprises an aperture stop that does not move during zooming,
wherein each distance between adjacent lens units changes during zooming, and
wherein the following inequalities are satisfied:
$$0.03 \leq fw / TL \leq 0.039$$
$$0.05 \leq f 1 / TL \leq 0.19$$
$$4. \leq ft / fw \leq 7.$$
$$- 2.4 \leq β r \leq - 1.27$$
where f1 is a focal length of the first lens unit, fw is a focal length of the zoom lens at a wide-angle end, ft is a focal length of the zoom lens at a telephoto end, TL is a distance on an optical axis from a lens surface closest to an object in the zoom lens to a final lens surface closest to an image plane in the zoom lens in an in-focus state on an object at infinity at the wide-angle end, plus an air-equivalent distance on the optical axis from the final lens surface to the image plane, and βr is a combined lateral magnification at the wide-angle end of all lens units that are closer to the image plane than a lens unit with negative refractive power closest to the image plane in the intermediate group.

2. A zoom lens comprising, in order from an object side to an image side:
a first lens unit with positive refractive power that does not move for zooming;
an intermediate group having two or more lens units that move for zooming; and
a rear lens unit,
wherein the zoom lens further comprises an aperture stop that moves during zooming,
wherein each distance between adjacent lens units changes during zooming, and
wherein the following inequalities are satisfied:
$$0.025 \leq fw / TL \leq 0.035$$
$$0.05 \leq f 1 / TL \leq 0.19$$
$$4. \leq ft / fw \leq 7.$$
where f1 is a focal length of the first lens unit, fw is a focal length of the zoom lens at a wide-angle end, ft is a focal length of the zoom lens at a telephoto end, and TL is a distance on an optical axis from a lens surface closest to an object in the zoom lens to a final lens surface closest to an image plane in the zoom lens in an in-focus state on an object at infinity at the wide-angle end, plus an air-equivalent distance on the optical axis from the final lens surface to the image plane.

3. The zoom lens according to claim 1, wherein the first lens unit consists of:
a first sub-lens unit with negative refractive power that does not move for focusing,
a second sub-lens unit with positive refractive power that moves for focusing, and
a third sub-lens unit with positive refractive power.

4. The zoom lens according to claim 1, wherein the following inequality is satisfied:
$$- 2.4 \leq f 1 / fv \leq - 0.3$$
where fv is a focal length of the lens unit with a largest absolute value of a lateral magnification at the telephoto end divided by a lateral magnification at the wide-angle end among the two or more lens units included in the intermediate group in the in-focus state on the object at infinity.

5. The zoom lens according to claim 3, wherein the following inequalities are satisfied:
$$- 1.5 \leq f 11 / f 1 \leq - 0.6$$
$$2. \leq f 13 / f 1 \leq 6.5$$
$$1.3 \leq f 13 / f 1 \leq 4.5$$
where f11 is a focal length of the first sub-lens unit, f12 is a focal length of the second sub-lens unit, and f13 is a focal length of the third sub-lens unit.

6. The zoom lens according to claim 1, wherein the following inequality is satisfied:
$$1.1 \leq LD 1 / f 1 \leq 6.5$$
where LD1 is a length on the optical axis from a lens surface closest to the object in the first lens unit to a lens surface closest to the image plane in the first lens unit.

7. The zoom lens according to claim 1, wherein the following inequality is satisfied:
$$51.5 ° \leq ω w \leq 65. °$$
where ow is a half angle of view at the wide-angle end, Y is an image height of the zoom lens, and ωw=arctan(Y/fw).

8. The zoom lens according to claim 1, wherein the following inequality is satisfied:
$$2. \leq Fnow \leq 3.5$$
where Fnow is a full aperture F-number of the zoom lens at the wide-angle end.

9. The zoom lens according to claim 1, wherein the following inequality is satisfied:
$$0.05 \leq fw / BFw \leq 0.43$$
where BFw is a distance on the optical axis from an image-side lens surface of a lens with refractive power closest to the image plane in the zoom lens to the image plane.

10. The zoom lens according to claim 1, wherein the following inequality is satisfied:
$$0.2 \leq LDs / TL \leq 0.6$$
where LDs is a distance on the optical axis from a lens surface closest to the object in the first lens unit to the aperture stop in the in-focus state on the object at infinity at the wide-angle end.

11. The zoom lens according to claim 1, wherein the following inequality is satisfied:
$$2.5 \leq ( f 1 + bok 1 ) / f 1 \leq 5.$$
where bok1 is a distance on the optical axis from a lens surface closest to the image plane in the first lens unit to a rear principal point of the first lens unit in the in-focus state on the object at infinity.

12. The zoom lens according to claim 1, wherein the following inequality is satisfied:
$$0.6 \leq ft / f 1 \leq 5. .$$

13. The zoom lens according to claim 1, wherein the following inequality is satisfied:
$$1.7 \leq f 1 / fw \leq 5.6 .$$

14. The zoom lens according to claim 3, wherein the first sub-lens unit includes two or more negative lenses.

15. The zoom lens according to claim 1, wherein the two or more lens units included in the intermediate group include three or more lens units.

16. An image pickup apparatus comprising:
a zoom lens; and
an image sensor configured to capture an object image through the zoom lens,
wherein the zoom lens includes, in order from an object side to an image side:
a first lens unit with positive refractive power that does not move for zooming,
an intermediate group having two or more lens units that move for zooming, and
a rear lens unit,
wherein the zoom lens further comprises an aperture stop that does not move during zooming,
wherein each distance between adjacent lens units changes during zooming, and
wherein the following inequalities are satisfied:
$$0.03 \leq fw / TL \leq 0.039$$
$$0.05 \leq f 1 / TL \leq 0.19$$
$$4. \leq ft / fw \leq 7.$$
$$- 2.4 \leq β r \leq - 1.27$$
where f1 is a focal length of the first lens unit, fw is a focal length of the zoom lens at a wide-angle end, ft is a focal length of the zoom lens at a telephoto end, TL is a distance on an optical axis from a lens surface closest to an object in the zoom lens to a final lens surface closest to an image plane in the zoom lens in an in-focus state on an object at infinity at the wide-angle end, plus an air-equivalent distance on the optical axis from the final lens surface to the image plane, and βr is a combined lateral magnification at the wide-angle end of all lens units that are closer to the image plane than a lens unit with negative refractive power closest to the image plane in the intermediate group.
